(19) United States
(12) Patent Application Publication
(10) Pub. No.: US 2026/0368882 A1
(43) Pub. Date: Nov. 19, 2026

(54) SYSTEMS AND METHODS OF DETERMINING BIOLOGICAL CONDITIONS OF CELLS

(71) Applicant: THE JOHNS HOPKINS UNIVERSITY, Baltimore, MD (US)

(72) Inventors: Jude Marvin PHILLIP, Baltimore, MD (US); Debonil MAITY, Baltimore, MD (US)

(21) Appl. No.: 19/103,284

(22) PCT Filed: Aug. 16, 2023
(86) PCT No.: PCT/US2023/030310

§ 371 Date: Feb. 12, 2025

Related U.S. Application Data
(60) Provisional application No. 63/398,885, filed on Aug. 18, 2022.

(51) Int. Cl. G06T 7/00; G06T 7/20; G06V 10/774; G06V 10/82; G06V 20/69

(52) U.S. Cl. CPC G06T 7/0012; G06T 7/20; G06V 10/82; G06V 20/698; G06T 2207/10016; G06T 2207/20081; G06T 2207/20084; G06T 2207/30024; G06T 2207/30241; G06V 10/774

(57) ABSTRACT

Examples may provide an electronic neural network that has been trained on a set of training data that comprises a plurality of harmonized cell motility data sets obtained from reference subjects that are each labeled with one or more biological conditions. The electronic neural network is configured to provide output biological conditions of cells from test subjects based upon one or more patterns or clusters of data points present in the plurality of harmonized cell motility data sets.

### CROSS-REFERENCE TO RELATED APPLICATIONS

This application is the national stage entry of International Patent Application No. PCT/US2023/030310, filed on Aug. 16, 2023, and published as WO 2024/039696 A1 on Feb. 22, 2024, which claims the benefit of U.S. Provisional Patent Application Ser. No. 63/398,885, filed on Aug. 18, 2022, which are hereby incorporated by reference in their entireties.

### FIELD

This disclosure relates generally to machine learning, e.g., in the context of medical applications, such as pathology.

### BACKGROUND

Single-cell profiling is important for the proper understanding and interpretation of cellular heterogeneity and biological phenotypes in homeostasis and disease. Recent developments in single-cell sequencing technologies and analyses have enabled the quantitative description of cell types, cell states and cell fates based on time-anchored snapshots of genetic, epigenetic or protein signatures. However, molecular inferences based solely on these types of sequencing data are limited to directly inform functional cell behaviors. Profiling cell motility and other dynamic properties of cells as they move and interact within local microenvironments provide key insights into functional cell behaviors. Furthermore, quantification of cell motility informs our understanding of many biological processes, including immune locomotion and surveillance and cancer metastasis. However, conventional cell motility data captured in vitro or in vivo are often performed on small numbers of homogeneous cells, and tend to be reported as averaged values over populations of cells, e.g. average speeds, average displacements. While in some ways averaging the motility parameters offer biological simplicity, it limits the ability to assess cellular heterogeneity, and to infer generalizable cell motility patterns that define single-cell behaviors per condition.

Combining single-cell profiling of cell motility with modern data science approaches and machine learning offer promising solutions to define functional cell behaviors across multiple conditions. Furthermore, performing these analyses in biological systems with known underlying molecular information (i.e. knockdowns of particular genes, drug treatments) present the potential to trace the influence of molecular programs of dynamic cell behaviors. Despite this promise, robust quantification of cell motility patterns to inform functional behaviors and heterogeneities of cells remain challenging. This is partly due to the lack of universal standards for acquiring cell motility data, (i.e. image acquisition settings, such as total imaging duration, acquisition intervals), and a lack of large publicly available cell motility datasets for comparative interrogation of motility trends and behaviors.

Accordingly, it is apparent that there is a need for additional methods of determining biological conditions of cells that use cell motility data that are of use in informing diagnostic, prognostic, and therapeutic decision-making processes.

### SUMMARY

The present disclosure provides, in certain aspects, an artificial intelligence (AI) system capable of determining biological conditions of cells from test subject. In some aspects, for example, the present disclosure provides a computational framework, sometimes referred to as halo, which stands for harmonized locomotion, to enable the direct integration and harmonization of motility datasets from multiple sources having different acquisition settings. In some embodiments, following data harmonization, haLo enables the robust identification and classification of single-cell motility behaviors, quantification of phenotypic heterogeneities, and provides a visualization scheme to quantitatively interpret biological conditions. These and other aspects will be apparent upon a complete review of the present disclosure, including the accompanying figures.

According to various embodiments, a computer-implemented method of determining a biological condition of a cell from a test subject is presented. The method includes: passing a cell motility data set obtained from the test subject through an electronic neural network, wherein the electronic neural network has been trained on a set of training data that comprises a plurality of harmonized cell motility data sets obtained from reference subjects that are each labeled with one or more biological conditions; and outputting from the electronic neural network the biological condition of the cell from the test subject based upon one or more patterns or clusters of data points present in the plurality of harmonized cell motility data sets.

Various optional features of the above embodiments include the following. Two or more of the plurality of cell motility data sets obtained from the reference subjects are substantially non-uniform with one another. The plurality of cell motility data sets comprises video images and/or tracking data of cells obtained from the reference subjects. The plurality of cell motility data sets comprises images of cells and/or the coordinates of cell trajectories in either two-dimensional (2D) or three-dimensional (3D) microenvironments, ex vivo or in vivo obtained from the reference subjects. The motility patterns of cells are quantified when taken out of the subjects or when the cells are in the subjects, using, for instance, intravital microscopy or the like. The plurality of cell motility data sets lacks averaged data points or parameters. Determining the biological condition of the cell from the test subject in substantially real-time. The cell motility data set obtained from the test subject comprises in vitro data points. The cell motility data set obtained from the test subject comprises ex vivo data points. The cell motility data set obtained from the test subject comprises in vivo data points. The plurality of harmonized cell motility data sets obtained from the reference subjects comprises in vitro data points. The plurality of harmonized cell motility data sets obtained from the reference subjects comprises ex vivo data points. The plurality of harmonized cell motility data sets obtained from the reference subjects comprises in vivo data points. Quantifying a cell motility value for the cell from the test subject. The biological conditions are selected from the group consisting of: a cell type, a disease state, a genotype, a phenotype, a drug exposure, a spatial heterogeneity, and a temporal heterogeneity. The plurality of harmonized cell motility data sets is obtained from multiple sources having different acquisition settings. The biological condition of the cell from the test subject comprises an identification and classification of a single-cell motility behavior, a quantification of phenotypic heterogeneities, a visualization scheme to quantitatively interpret the biological condition, and/or predict motility patterns of the cell. Mapping temporal transitions among different cell motility behaviors exhibited by the cell.

According to various embodiments, a system for determining a biological condition of a cell from a test subject using an electronic neural network is presented. The system includes a processor; and a memory communicatively coupled to the processor, the memory storing instructions which, when executed on the processor, perform operations including: passing a cell motility data set obtained from the test subject through an electronic neural network, wherein the electronic neural network has been trained on a set of training data that comprises a plurality of harmonized cell motility data sets obtained from reference subjects that are each labeled with one or more biological conditions; and outputting from the electronic neural network the biological condition of the cell from the test subject based upon one or more patterns or clusters of data points present in the plurality of harmonized cell motility data sets.

Various optional features of the above embodiments include the following. Two or more of the plurality of cell motility data sets obtained from the reference subjects are substantially non-uniform with one another. The plurality of cell motility data sets comprises video images and/or tracking data of cells obtained from the reference subjects. The plurality of cell motility data sets comprises images of cells and/or the coordinates of cell trajectories in either two-dimensional (2D) or three-dimensional (3D) microenvironments obtained from the reference subjects. The plurality of cell motility data sets lacks averaged data points or parameters. The cell motility data set obtained from the test subject comprises in vitro data points. The cell motility data set obtained from the test subject comprises ex vivo data points. The cell motility data set obtained from the test subject comprises in vivo data points. The plurality of harmonized cell motility data sets obtained from the reference subjects comprises in vitro data points. The plurality of harmonized cell motility data sets obtained from the reference subjects comprises ex vivo data points. The plurality of harmonized cell motility data sets obtained from the reference subjects comprises in vivo data points. The biological conditions are selected from the group consisting of: a cell type, a disease state, a genotype, a phenotype, a drug exposure, a spatial heterogeneity, and a temporal heterogeneity. The plurality of harmonized cell motility data sets is obtained from multiple sources having different acquisition settings. The biological condition of the cell from the test subject comprises an identification and classification of a single-cell motility behavior, a quantification of phenotypic heterogeneities, a visualization scheme to quantitatively interpret the biological condition, and/or predict motility patterns of the cell.

### DRAWINGS

The above and/or other aspects and advantages will become more apparent and more readily appreciated from the following detailed description of examples, taken in conjunction with the accompanying drawings, in which:

FIG. 1 is a flow chart that schematically shows exemplary method steps of determining a biological condition of a cell from a test subject according to some aspects disclosed herein; and

FIG. 2 is a schematic diagram of an exemplary system suitable for use with certain aspects disclosed herein.

FIGS. 3A-3F. Data harmonization across multiple datasets. A. trajectory of a single HT1080 cell showing the effects of varying interval times. B-C. trajectory of a single ht1080 cells and the prediction of cell locations per time point based on interpolation and pMC-2 for symmetric (B) and asymmetric (C) multiples of the real interval time. D. Mean squared displacements (MSD) of primary human dermal fibroblasts (n=873 cells) as a function of time lag. Interpolation and various pMC factors demonstrate short and long time scale behaviors relative to the MSD generated from the actual cell trajectories. E. Estimate of eight motility parameters based on APRW model. F. Heatmap showing optimal time interval across all conditions.

FIGS. 4A-4L. Classifying cell motility patterns across short durations. A. heatmap showing the magnitude of eight motility parameters per cell (n=74,253 cells). Each row represents a single cell and each column represents a motility parameter. B. Line plot showing the relationship between the number of clusters and the inertia/silhouette ratios. C. Heatmap of cluster coherence factors showing that cells classified within each cluster exhibit small distances from their cluster centroid. D. Two-dimensional tSNE plot showing the 17 motility clusters that further separation into 4 classes, each dot denotes a single cell. E. Two-dimensional t-SNE plot showing the magnitude of the eight motility parameters per cluster region, each dot denotes a single cell. F. Visualization of cell trajectories for cells classified within each cluster, top panel shows the origin-centered trajectories for all cells within a given cluster, bottom panel shows 16 randomly selected cells per clusters. G-H. Confusion matrix showing the classification predictions using linear SVM for cells 90:10 split of data (G) and the prediction classifications using linear SVM of 75,000 simulated cell trajectories (H). I. Bar plot showing the abundance of cells classified within each of the 17 clusters for monocytes from 3 donors (plots on left) and matched cells exposed to conditioned media (plots on right). J. Dot plot showing the decrease in heterogeneity after exposure to conditioned media, each dot denotes a donor. K. Cross-correlation heatmap showing that cells exposed to conditioned media were more similar to other exposed cells then their respective baselines. L. Box-and-whisker plots showing the magnitude of conventional motility parameters and the increase in motility after exposure to conditioned media.

FIGS. 5A-5J. Classifying cell motility patters across long durations. A. Heatmap showing eight motility parameters per cell (n=24,753 cells). Each row represents a single cell and each column represents a motility parameter. B. Line plot showing the relationship between the number of clusters and the inertia/silhouette ratios. C. Heatmap of cluster coherence factors showing that cells classified within each cluster exhibit small distances from their cluster centroid. D. Two-dimensional t-SNE plot showing the 25 identified clusters and their separation into 4 classes, each dot denotes a single cell. E. Two-dimensional t-SNE plot showing the magnitude of the eight motility parameters per cluster region, each dot denotes a single cell. F. Visualization of cell trajectories for cells classified within each cluster, top panel shows the origin-centered trajectories for all cells within a cluster, and bottom panel shows 16 randomly selected cells per clusters. G. Confusion matrix showing prediction classification using linear SVM for cells 90:10 split of data. H. Sankey plot showing the transitions based on the fractional abundance of cells within each short duration class (n=3 time segments), and how they ultimately connect to the four long duration classes. I. Sankey plots showing the magnitude of the conditional probabilities for cells transitioning across short duration classes. J. Heatmap and complimentary box-and-whisker plots showing the stability fractions of short duration classes.

FIGS. 6A-6L. Quantifying functional heterogeneity and biological insights using haLo. A. Cross-correlation heatmap highlighting the grouping of the 409 cellular conditions based on cell behavior similarities. B. Two-dimensional t-SNE plot showing the 409 conditions painted based on the identified groupings, each dot denotes a single biological condition (n=409). C. Single cell trajectories of LY12 cells as a function of increasing collagen concentrations. Top panel shows origin-centered trajectories for all cells analyzed, and bottom panel shows 25 randomly selected cells per condition. D. Two-dimensional t-SNE plot showing the bi-phasic/switching effect with increasing collagen concentration. E. Heatmap showing the abundance of cells within each cluster per collagen concentration. Line plot on the right shows the change in the Shannon entropy, denoting cellular heterogeneity. F. Sankey plots showing the temporal transitions of cells across short duration classes as a function of increasing concentration. G. Heatmap showing the average values of motility parameters with increasing collagen concentration. H. Two-dimensional t-SNE plot showing the location of matched 2D and 3D conditions of ht1080 cells. I. Box plot showing the Shannon entropy of cell in 2D and 3D environments. J. ROC curve showing accuracy of prediction, denoted by the true positive rates and false positive rates, for higher order motility parameters and different types of entropy. K-L. Box-and-whisker plots showing the prediction accuracy (K) and area under the curve (L) for higher order motility parameters and different types of entropy.

### DEFINITIONS

In order for the present disclosure to be more readily understood, certain terms are first defined below. Additional definitions for the following terms and other terms may be set forth throughout the specification. If a definition of a term set forth below is inconsistent with a definition in an application or patent that is incorporated by reference, the definition set forth in this application should be used to understand the meaning of the term.

As used in this specification and the appended claims, the singular forms “a,” “an,” and “the” include plural references unless the context clearly dictates otherwise. Thus, for example, a reference to “a method” includes one or more methods, and/or steps of the type described herein and/or which will become apparent to those persons skilled in the art upon reading this disclosure and so forth.

It is also to be understood that the terminology used herein is for the purpose of describing particular embodiments only and is not intended to be limiting. Further, unless defined otherwise, all technical and scientific terms used herein have the same meaning as commonly understood by one of ordinary skill in the art to which this disclosure pertains. In describing and claiming the methods, systems, and computer readable media, the following terminology, and grammatical variants thereof, will be used in accordance with the definitions set forth below.

Classifier. As used herein, “classifier” generally refers to algorithm computer code that receives, as input, test data and produces, as output, a classification of the input data as belonging to one or another class.

Data set: As used herein, “data set” refers to a group or collection of information, values, or data points related to or associated with one or more objects, records, and/or variables. In some embodiments, a given data set is organized as, or included as part of, a matrix or tabular data structure. In some embodiments, a data set is encoded as a feature vector corresponding to a given object, record, and/or variable, such as a given test or reference subject. For example, a medical data set for a given subject can include one or more observed values of one or more variables associated with that subject.

Electronic neural network: As used herein, “electronic neural network” refers to a machine learning algorithm or model that includes layers of at least partially interconnected artificial neurons (e.g., perceptrons or nodes) organized as input and output layers with one or more intervening hidden layers that together form a network that is or can be trained to classify data, such as test subject medical data sets (e.g., medical images or the like).

Labeled: As used herein, “labeled” in the context of data sets or points refers to data that is classified as, or otherwise associated with, having or lacking a given characteristic or property.

Machine Learning Algorithm: As used herein, “machine learning algorithm” generally refers to an algorithm, executed by computer, that automates analytical model building, e.g., for clustering, classification or pattern recognition. Machine learning algorithms may be supervised or unsupervised. Learning algorithms include, for example, artificial neural networks (e.g., back propagation networks), discriminant analyses (e.g., Bayesian classifier or Fisher's analysis), multiple-instance learning (MIL), support vector machines, decision trees (e.g., recursive partitioning processes such as CART-classification and regression trees, or random forests), linear classifiers (e.g., multiple linear regression (MLR), partial least squares (PLS) regression, and principal components regression), hierarchical clustering, and cluster analysis. A dataset on which a machine learning algorithm learns can be referred to as “training data.” A model produced using a machine learning algorithm is generally referred to herein as a “machine learning model.”

Subject: As used herein, “subject” or “test subject” refers to an animal, such as a mammalian species (e.g., human) or avian (e.g., bird) species. More specifically, a subject can be a vertebrate, e.g., a mammal such as a mouse, a primate, a simian or a human. Animals include farm animals (e.g., production cattle, dairy cattle, poultry, horses, pigs, and the like), sport animals, and companion animals (e.g., pets or support animals). A subject can be a healthy individual, an individual that has or is suspected of having a disease or pathology or a predisposition to the disease or pathology, or an individual that is in need of therapy or suspected of needing therapy. The terms “individual” or “patient” are intended to be interchangeable with “subject.” A “reference subject” refers to a subject known to have or lack specific properties (e.g., a known pathology, such as melanoma and/or the like).

Value: As used herein, “value” generally refers to an entry in a dataset that can be anything that characterizes the feature to which the value refers. This includes, without limitation, numbers, words or phrases, symbols (e.g., + or −) or degrees.

### DESCRIPTION OF THE EMBODIMENTS

Reference will now be made in detail to example implementations. These embodiments are described in sufficient detail to enable those skilled in the art to practice the invention and it is to be understood that other embodiments may be utilized and that changes may be made without departing from the scope of the invention. The following description is, therefore, merely exemplary.

### I. Introduction

Cell motility is essential to many biological processes as cells navigate and interact within local microenvironments. Currently, most methods to quantify cell motility rely on the ability to follow and track individual cells. However, results from these approaches are typically reported as averaged values across cell populations. While these approaches offer biological simplicity, it limits the ability to assess cellular heterogeneity and to infer generalizable patterns of single-cell behaviors at baseline or after perturbations.

In some aspects of the present disclosure, a computational framework (sometimes referred to as “harmonized locomotion” or “haLo”) is provided that takes advantage of the single-cell nature of cell motility data to identify and classify distinct spatio-temporal behaviors of single-cells. Using haLo, for example, the ability to robustly classify single-cell motility patterns in a large dataset (n=74,253 cells), quantify spatio-temporal heterogeneities, determine motility patterns in unclassified cells, and provide a visualization scheme for direct interpretation of dynamic cell behaviors, among other attributes, are demonstrated. Furthermore, as an example, we investigated the biphasic spatial and temporal responses of T-lymphoma cells moving in Collagen-I gels of varying collagen concentrations, and predicted the dimensionality (2D vs. 3D) of matched cellular conditions based solely on spatio-temporal heterogeneities. Together, the aspects of the present disclosure provide a multivariate framework to robustly classify emergent patterns of single-cell behaviors, highlighting cellular heterogeneity as a key feature that establishes the behaviors of cellular populations.

In some embodiments, haLo is a computational framework that combines experimentally-derived cell movements with machine/deep learning approaches to profile and quantify distinct cell behaviors as a function of conditions/perturbations. In some embodiments, haLo is highly automated, possessing applications both as a stand-alone platform/tool as well as in combination with other single-cell and imaging technologies.

The halo framework has numerous applications. To illustrate, in some embodiments, haLo is used to determine, evaluate, and/or validate predictive markers for precision health and precision medicine applications; e.g. predict metastatic potential of cells based on classified behaviors, predict age/age-associated diseases/cancer/frailty/aging trajectories/resilience (i.e. propensity to heal, rebound after injury or surgery), predict efficacy of immunotherapies (CAR-T). In some embodiments, haLo is used in high-throughput functional screens or screening platforms (e.g. drug/CRISPR/RNA) to evaluate and validate effects of therapeutic agents based on mapping the response profiles of cells, per condition/per perturbation. This highly automated approach can be used similar to how morphology or other metabolic readouts are currently being used in this space. However, using our readouts, which capture dynamic functional measurements, allowing higher signal-to-noise and enhanced sensitivity as opposed to a snapshot of response. The platform is also capable of profiling cells in 2D or 3D so can also open opportunities for in vivo imaging (and is not bound to a particular type of microscopy/optical system).

In other exemplary embodiments, the haLo framework is coupled with other single-cell technologies for molecular profiling, e.g. scRNA-seq/scATAC seq/CyTOF, to provide functional associations or connections with underlying molecular determinants or pathways. In some embodiments, this is multiplexed in the same cells. In some embodiments, for example, samples from the same donor/patient can be split then running single-cell molecular profiling with one set, and measuring cell dynamics with the other. Using these results, we can perform quasi-single cell clustering, we can iterate the phenotypes and map the functional clusters from halo to the molecular clusters from single cell data. In some embodiments, the framework Combines the haLo readout with CRISPR/RNA/drug screens where we can probe the direct effects of the molecular manipulations and then associate directly to the dynamic cell behaviors and phenotypes. In some embodiments, the processes disclosed herein include tagging or barcoding and measuring cell behaviors with halo, then harvesting cells after experiments, after which single-cell molecular analysis is optionally also performed.

As additional exemplary embodiments, haLo is used to profile effects of exposures/perturbations (e.g. environmental, pollution, therapeutic, disease states, etc.) on cellular responses and behaviors in living subjects (human, mice, or the like). This can have applications in dynamic/progressive monitoring approaches. In still other embodiments, haLo is used to predict and classify cell types based on dynamic cell behaviors and the abundances of cells within distinct single-cell motility and morpho-dynamic clusters. These and other attributes will be apparent upon a complete review of the present disclosure, including the accompanying figures.

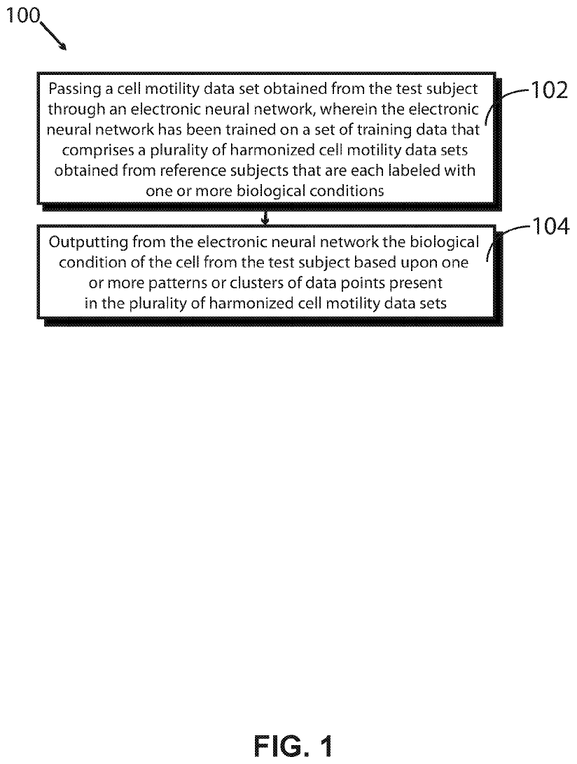

In some aspects, the present disclosure provides computer-implemented methods of determining a biological condition of a cell from a test subject. To illustrate, FIG. 1 is a flow chart that schematically shows certain of these exemplary method steps. As shown, method 100 includes passing a cell motility data set obtained from the test subject through an electronic neural network (step 102). The electronic neural network has been trained on a set of training data that comprises a plurality of harmonized cell motility data sets obtained from reference subjects that are each labeled with one or more biological conditions. Method 100 also includes outputting from the electronic neural network the biological condition of the cell from the test subject based upon one or more patterns or clusters of data points present in the plurality of harmonized cell motility data sets (step 104).

In some embodiments, two or more of the plurality of cell motility data sets obtained from the reference subjects are substantially non-uniform with one another. In some embodiments, the plurality of cell motility data sets comprises video images of cells obtained from the reference subjects. In some embodiments, the plurality of cell motility data sets comprises images of cells in either two-dimensional (2D) or three-dimensional (3D) microenvironments obtained from the reference subjects. In some embodiments, the plurality of cell motility data sets lacks averaged data points or parameters. In some embodiments, method 100 includes determining the biological condition (e.g., one or more biological conditions (e.g., about 2, about 3, about 4, about 5, about 6, about 7, about 8, about 9, about 10, about 20, about 30, about 40, about 50, about 60, about 70, about 80, about 90, about 100, about 150, about 200, about 250, about 300, about 350, about 400, about 450, about 500, or more biological conditions)) of the cell from the test subject in substantially real-time. In some embodiments, the cell motility data set obtained from the test subject comprises in vitro data points. In some embodiments, the cell motility data set obtained from the test subject comprises in vivo data points. In some embodiments, the plurality of harmonized cell motility data sets obtained from the reference subjects comprises in vitro/ex vivo data points. In some embodiments, the plurality of harmonized cell motility data sets obtained from the reference subjects comprises in vivo data points. In some embodiments, method 100 includes quantifying a cell motility value for the cell from the test subject. In some embodiments, the biological conditions are selected from one or more of, for example, a cell type, a disease state (e.g., a cancerous cell), a genotype, a phenotype, a drug exposure, a spatial heterogeneity, and a temporal heterogeneity, among many other conditions. In some embodiments, the plurality of harmonized cell motility data sets is obtained from multiple sources having different acquisition settings. In some embodiments, the biological condition of the cell from the test subject comprises an identification and classification of a single-cell motility behavior, a quantification of phenotypic heterogeneities, a visualization scheme to quantitatively interpret the biological condition, and/or predict motility patterns of the cell. Mapping temporal transitions among different cell motility behaviors exhibited by the cell.

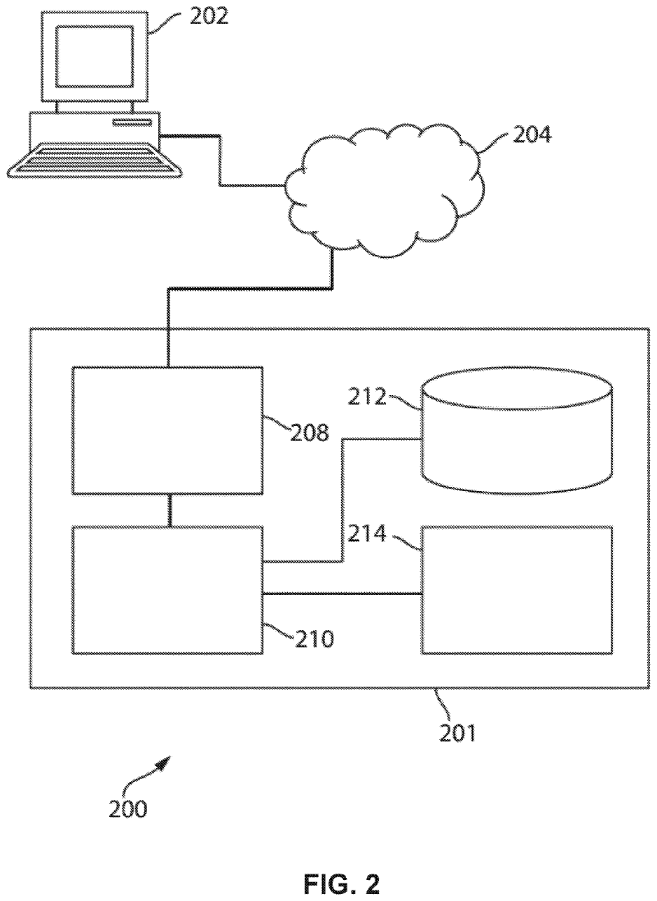

FIG. 2 is a schematic diagram of a hardware computer system 200 suitable for implementing various embodiments. For example, FIG. 2 illustrates various hardware, software, and other resources that can be used in implementations of any of methods disclosed herein, including method 100 and/or one or more instances of an electronic neural network. System 200 includes training corpus source 202 and computer 201. Training corpus source 202 and computer 201 may be communicatively coupled by way of one or more networks 204, e.g., the internet.

Training corpus source 202 may include an electronic clinical records system, such as an LIS, a database, a compendium of clinical data, or any other source of cell motility data suitable for use as a training corpus as disclosed herein. According to some embodiments, each component is implemented as a vector, such as a feature vector, that represents a respective tile. Thus, the term “component” refers to both a tile and a feature vector representing a tile.

Computer 201 may be implemented as any of a desktop computer, a laptop computer, can be incorporated in one or more servers, clusters, or other computers or hardware resources, or can be implemented using cloud-based resources. Computer 201 includes volatile memory 214 and persistent memory 212, the latter of which can store computer-readable instructions, that, when executed by electronic processor 210, configure computer 201 to perform any of the methods disclosed herein, including method 100, and/or form or store any electronic neural network, and/or perform any classification technique as described herein. Computer 201 further includes network interface 208, which communicatively couples computer 201 to training corpus source 202 via network 204. Other configurations of system 200, associated network connections, and other hardware, software, and service resources are possible.

Certain embodiments can be performed using a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes.

### II. Description of Example Embodiments

Using haLo, we demonstrate the ability to combine non-uniform cell motility datasets to profile 74,253 single-cells spanning 409 biological conditions. These biological conditions include different cell types, genetic and drug perturbations for cells in either two-dimensional (2D) or three-dimensional (3D) microenvironments. With this combined dataset we 1) identify and classify distinct cell motility behaviors at single-cell resolution for short (2.5 hours) and long (8 hours) durations, 2) determine phenotypic heterogeneities per condition (i.e. spatial and temporal), and 3) predict the motility patterns for previously unclassified cells. Furthermore, we show the ability to map temporal transitions among different cell motility behaviors to enable inferences that are typically limited due to the assumption of time-invariance; which is a key assumption in most motility analyses. As biological proof of concepts, we applied haLo to experimental conditions of T-lymphoma cells moving in 3D Collagen-I gels of varying collagen concentrations, and predict the dimensionality of cells (2D vs. 3D) from 60 matched conditions based solely on the magnitude of spatial and temporal heterogeneities. We also show that cellular heterogeneity is a defining feature of cell motility, with experimental perturbations inducing redistributions that shift the abundances of cells among distinct cell motility patterns and behaviors. Finally, we provide a large, annotated cell motility dataset to directly compare motility patterns within user-generated datasets.

### Results

### Data Acquisition and Curation

To develop a computational framework for classifying universal patterns and behaviors of single-cells across multiple conditions, we combined existing and newly acquired cell motility datasets. All cell trajectories presented were derived from time-lapse movies collected using brightfield or phase-contrast imaging. Cells were tracked using MetaMorph, and x-y trajectories across all experimental conditions had total imaging durations ranging between 2.5 to 16 hours, with image acquisition intervals ranging from 2 to 10 minutes.

### Image Acquisition Time Determines the Shape of Cell Movement Trajectories

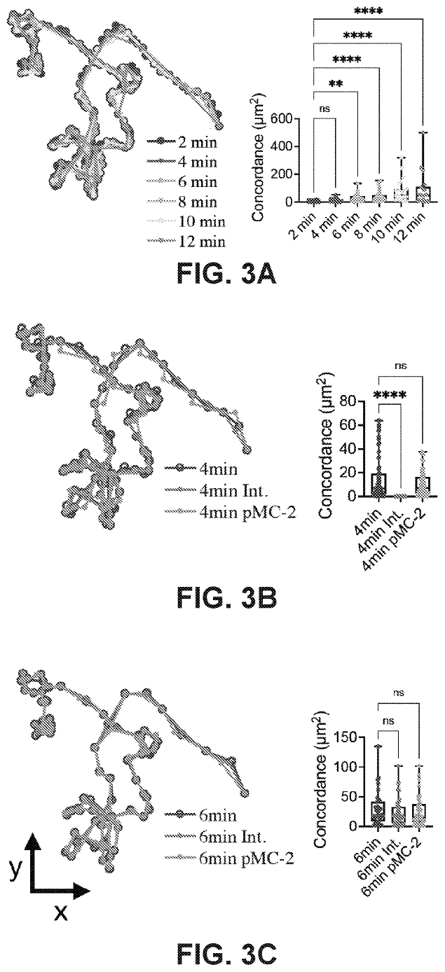

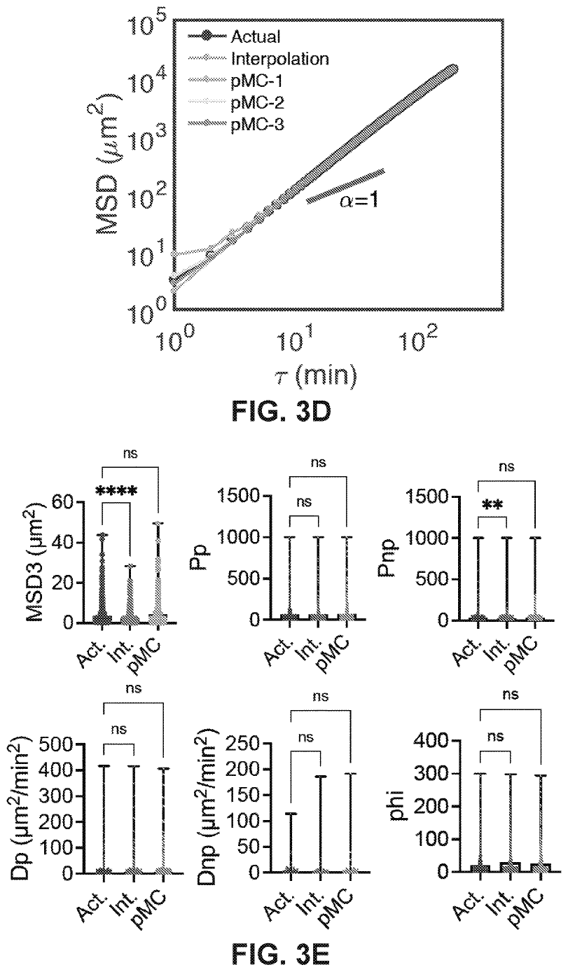

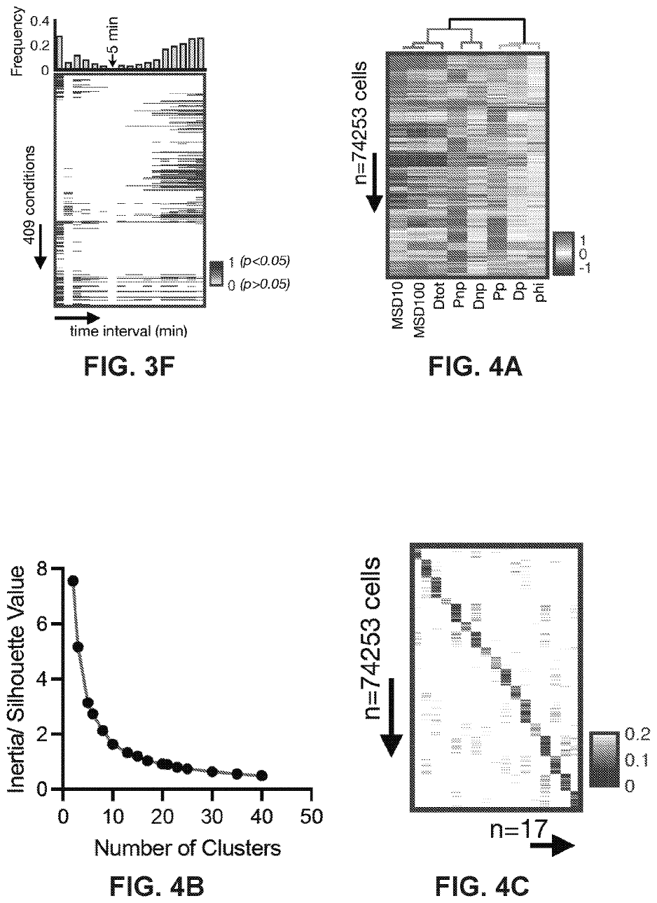

Currently, there are no universal standards for acquiring cell motility data in terms of total acquisition duration or image acquisition intervals. To combine motility datasets across multiple conditions (n=409) from multiple sources, we first needed to develop a method to integrate the data without introducing noise and artifacts into the datasets. This meant that we needed a way to directly combine datasets that were independent of both the total duration and the acquisition intervals. To do this we first restricted the total imaging duration to 2.5 hours in order to maximize the total number of cells, then we evaluated the effective contribution of the image acquisition intervals (i.e. time between subsequent images) on the magnitude of cell motility. Using a test case of HT1080 fibrosarcoma cells moving in 3D Collagen-I gels, we in-silico varied the time-intervals from the most time-resolved—i.e. 2 minutes, to a degraded time-resolution of 10 minutes (FIG. 3A). Here, varying the time intervals are as simple as leaving out intervening points from the fully time-resolved trajectory. Results indicated that the interval times significantly impacted the shapes of the cell trajectories, which was more prominent in highly motile cells. To quantify this deviation, we computed the concordance among cell trajectories of varying time intervals (FIG. 3A). The concordance is calculated as the geometric similarities among cell trajectories, based on the areas of triangles formed between intervening points along a given trajectory. Together, these results highlight the notion that acquisition intervals contribute significantly to the magnitude of the perceived motility and that the temporal resolution matters, i.e. cell movements based on 2-minute intervals do not equal cell movement at 10-minute intervals.

### Harmonizing Single-Cell Motility Data Across Multiple Datasets

Given the importance of interval times on the shape of cell movement trajectories, we proceeded to develop a robust way to determine the intermediate x-y locations along the movement trajectories of cells. Using geometric interpolation, we identified spatially weighted cell locations for symmetric (midpoint) and asymmetric multiples of the acquisition-interval times (FIG. 3B-C). We observed that while interpolated cell locations from asymmetric multiples of the interval times showed no statistical differences in the concordance relative to real data points (FIG. 3C), symmetric multiples of the interval times using interpolation showed significant deviations (FIG. 3B). To correct this, we developed a pseudo-Monte Carlo (pMC) approach that weights a small directional propensity to the interpolated locations to estimate the location of cells at a given time point (see Methods). With this, we showed that a pMC factor of 2.01 (pMC-2) worked well across all conditions, generating similar concordances to the trajectories generated using real data points, for both the symmetric and asymmetric conditions (FIG. 3B-C). Furthermore, plots of the mean squared displacements (MSD) showed that pMC-2 was capable of replicating both short and long time-scale behaviors, whereas interpolation showed significant deviations at short time-scales (FIG. 3D). To further confirm this, we computed motility parameters based on the anisotropic persistent random walk (APRW) model, a framework that acknowledges that cells do not always follow random walks on 2D or 3D substrates. From this analysis we observed no statistical differences between real trajectories and the reconstructed trajectories using pMC-2 for any of the eight parameters assessed. However, interpolation showed differences in some motility parameters including short-time MSD and the persistence time in the secondary axis of migration (FIG. 3E).

Using pMC-2 reconstructed trajectories across all conditions (n=409), we asked whether there was an optimal interval time that worked across all conditions, allowing the seamless integration of multiple datasets. Taking the 74,253 single cells, we iteratively varied the interval times between 2 and 10 minutes for every cell, then computed the p-values relative to the real acquisition intervals per cell and per condition. Results indicated that an interval time of 5-minute worked well across all conditions, as indicated by the least number of conditions having p-values greater than 0.05 (FIG. 3F) relative to the ground truth of each cell (i.e. highest time resolution). With this result, we converted all conditions to have an interval time of 5 minutes and a total duration of 2.5 hours. We chose 2.5 hours not only to maximize the number of cells within our dataset, but it also represents a time-scale comparable to what can be achieved for both in vivo and in vitro systems.

Taken altogether, we show the ability to combine and integrate non-uniform cell motility datasets that span multiple conditions and acquisition intervals.

### Classifying Functional Cell Behaviors at Single-Cell Resolution

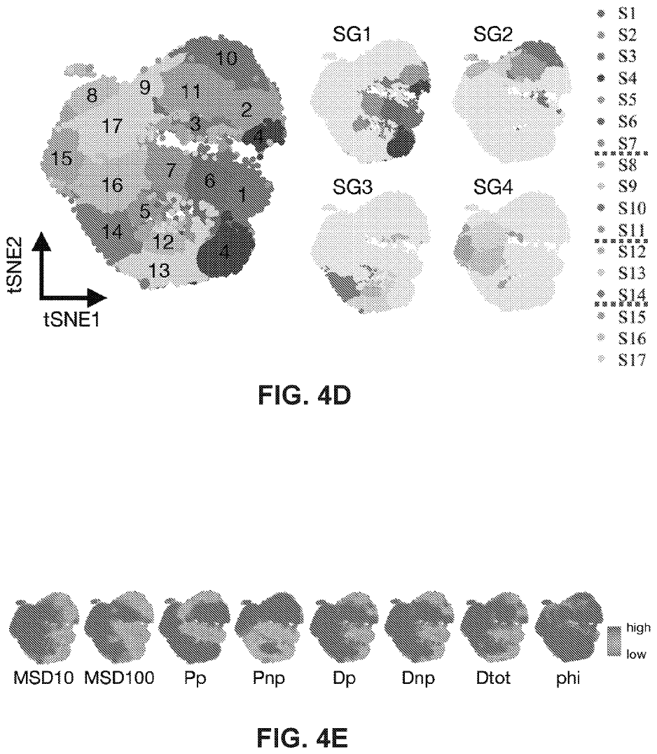

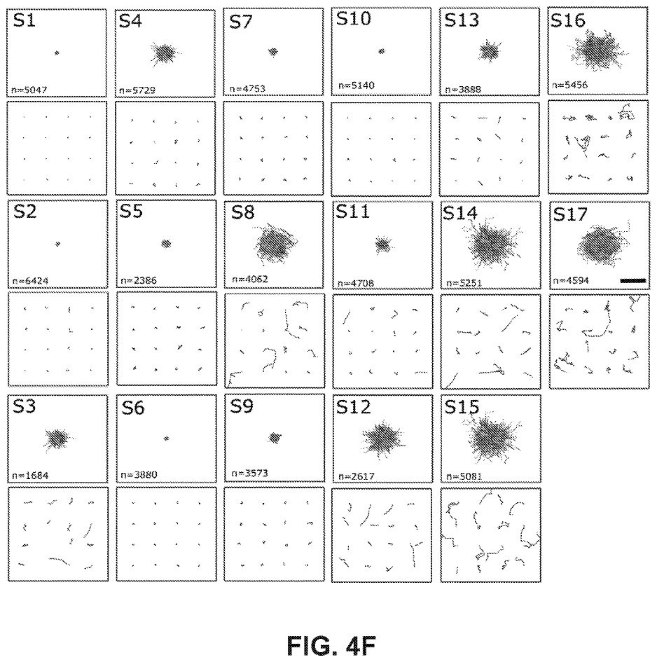

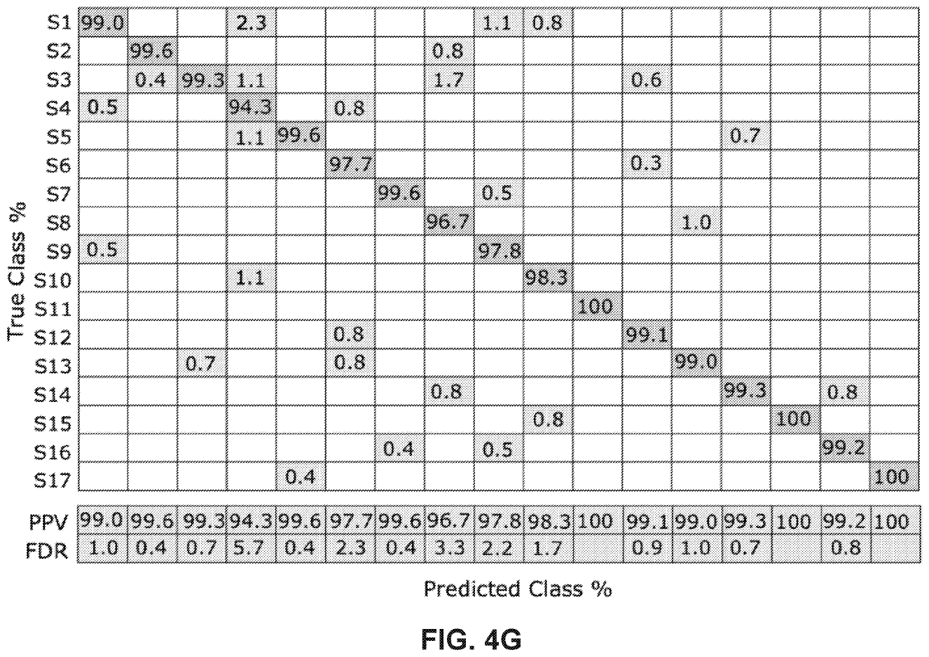

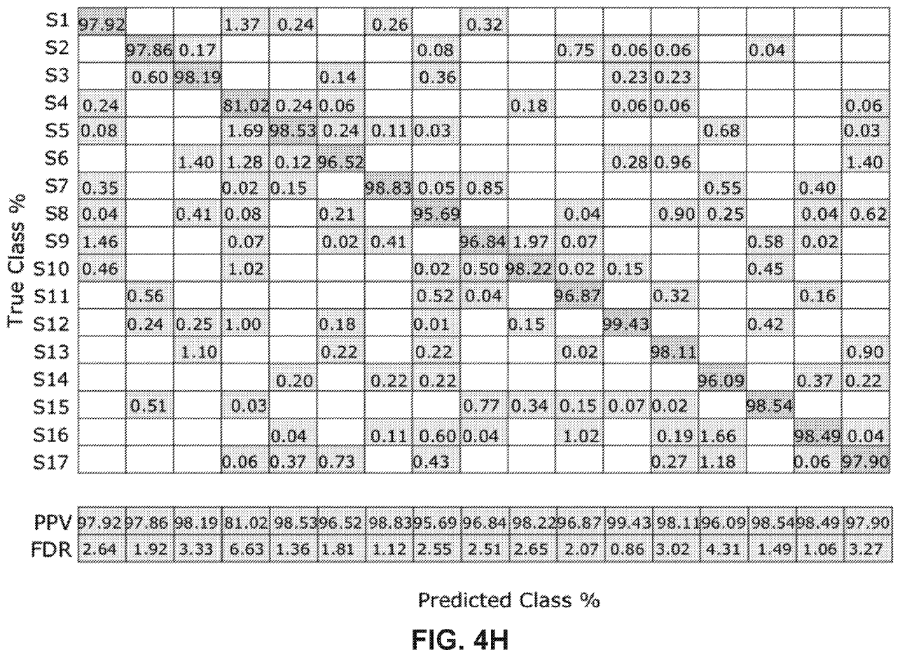

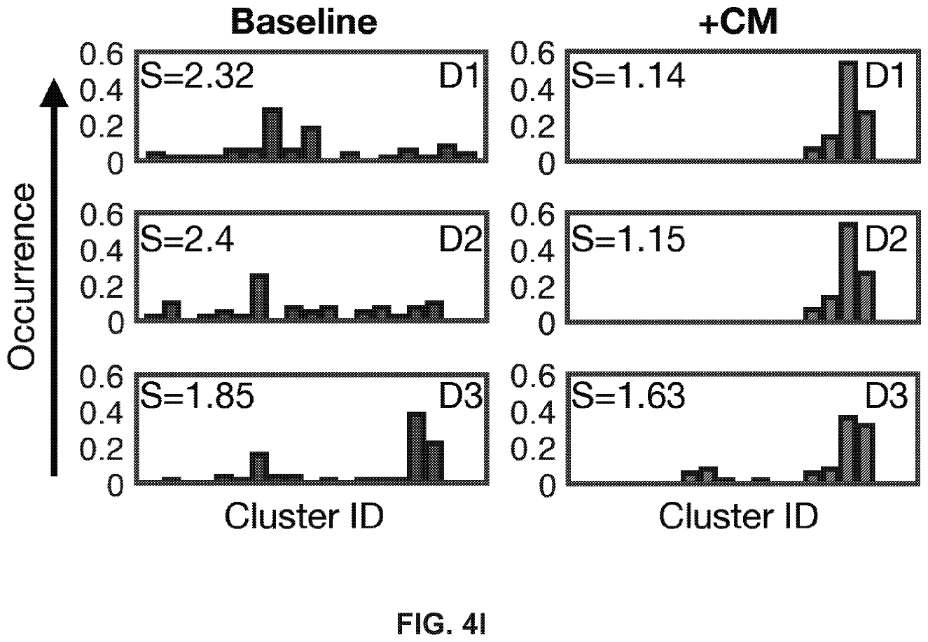

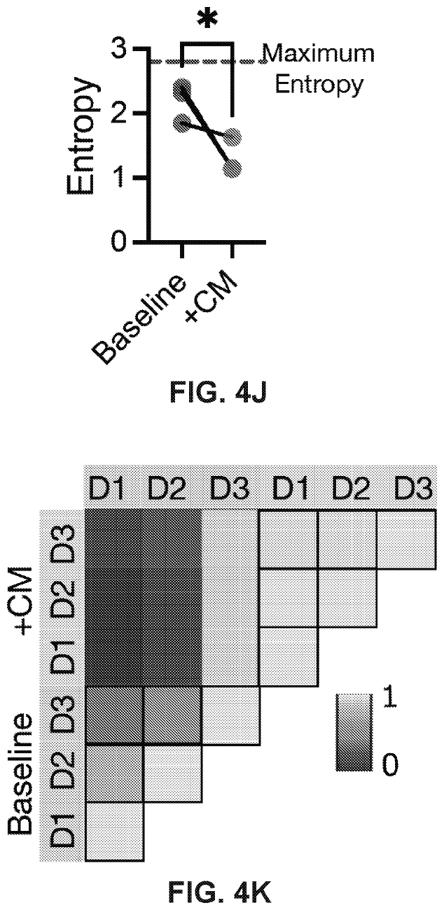

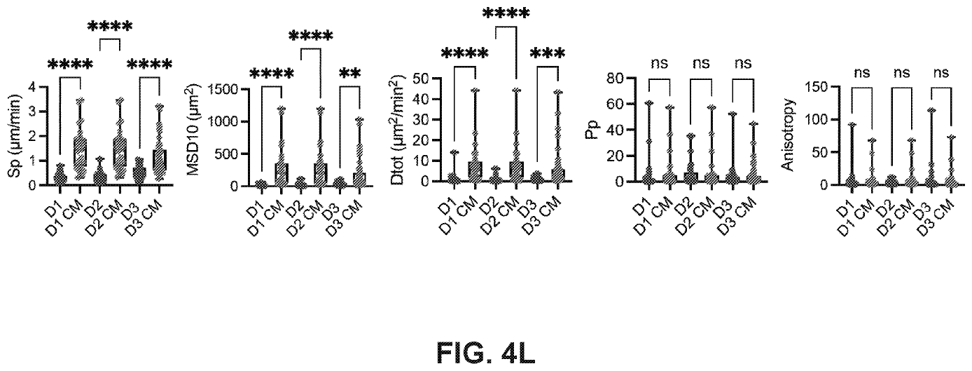

Using this new harmonized dataset, we asked whether we could identify distinct patterns of cell movements across all conditions. Using the 74,253 single-cells, we computed eight motility parameters based on the APRW model (see Methods), which we previously showed to describe critical characteristic of cell movements. These parameters include, short and long time-scale mean squared displacements (MSD10, MSD100), persistence times in the primary and secondary axes of migration (Pp, Pnp), total diffusivities and diffusivities in the primary and secondary axes of migration (Dtot, Dp, Dnp), and the anisotropic index that describes the spatial persistence (φ) (see Methods). Using k-means clustering together with calculations of the inertia and silhouette values, we determined inherent cell-based groupings that divided into 17 distinct patterns of cell motility (FIG. 4A-B). To confirm this classification, we calculated the coherence factor based on the vector-distances of every cell from each cluster-centroid. Results showed the expected staircase plot, highlighting the notion that cells classified within each cluster exhibited small distances from their assigned cluster centroids, and significant distances relative to the other unassigned cluster-centroids (FIG. 4C).

Using two-dimensional t-stochastic neighbor embedding (tSNE), we plotted all 74,253 cells and painted each cell based on the designated motility cluster (n=17 clusters). This showed that each cell clustered within close proximity to other cells classified within the same cluster (S1 to S17). Clusters were further grouped using unsupervised hierarchical clustering to describe gross similarities in cell behaviors, resulting in four behavior classes (SG1, SG2, SG3, SG4) (FIG. 4D). Each cluster and corresponding class showed intrinsic patterns that were defined based on the magnitude of the eight motility parameters (FIG. 4E). To visually confirm that different clusters denoted differential cell motility behaviors, we plotted the trajectories of cells classified within each cluster, highlighting clear differences in cell behaviors per motility cluster (FIG. 4F).

Together, we demonstrate a multivariate approach to robustly identify and classify distinct single-cell motility patterns across multiple datasets.

### Predicting Cell Motility Clusters in Unclassified Cells

Prompted by the robust classification of cells across multiple datasets, we asked whether we could predict the motility cluster of unclassified cells. To do this, we performed a randomized 90:10 split (training and validation sets) of the combined dataset (n=74,253 single cells). Using 90% of cells, we trained a machine learning algorithm using linear support vector machine (SVM), then applied the trained classification model to the remaining 10% of unclassified cells (see Methods). Our analysis showed a 98.7% accuracy across all clusters (FIG. 4G), where the true classes of cells within each cluster was determined based on the initial classification using all 74,253 cells. To further confirm the classification scheme and show the ability to predict the motility cluster in previously unclassified cells, we simulated 75,000 new trajectories (see Methods) then performed the classification using the SVM model trained on the 74,253 cells, achieving 96.7% accuracy across all clusters (FIG. 4H). Here, the true class of each simulated cell was determined by performing an iterative analysis to re-classify all the cells adding one new unclassified cell (simulated cell) each time, (i.e. re-training on 74,253 cells+1 cell, 75,000 times).

Together, we demonstrate the robust prediction of single-cell motility patterns using a trained machine learning model based on the eight key motility parameters that describe dynamic cellular behaviors.

Cell Motility Patterns Define Phenotypic Shifts and Heterogeneity of primary monocytes

To demonstrate the biological utility of our approach, we collected peripheral blood mononuclear cells from three healthy donors and isolated monocyte populations (CD14+) from each donor. Using 3D time-lapse microscopy, we imaged the monocytes moving in three-dimensional collagen gels (2 mg/ml) for 3 hours at 5 minute intervals, out of which 2.5 hours were used for analysis. In a fraction of the monocytes from each donor, we applied a chemical perturbation by exposing monocytes to conditioned media taken from breast cancer cells. From these movies we generated the coordinates of each cell trajectory, then performed classification using the trained SVM model described above. We observed that while each donor exhibited their own baseline profile based on the abundance of cells within each motility cluster, there were overt similarities across all donors (FIG. 4I). Interestingly, cells exposed to conditioned media (+CM), we observed a significant shift in the motility patterns relative to their baseline. The exposed monocytes from all three donors showed a similar shift to cells having elevated abundances of motility clusters S12, S13, S14, and S15, corresponding to patterns that describe highly motile cells. Furthermore, these shifts were associated with decreased phenotypic heterogeneity, as measured by the Shannon entropy (FIG. 4J), and a higher correlation among CM-exposed monocytes as opposed to each donor's baseline (FIG. 4K). Based on this shift towards patterns of higher motility, we plotted bulk motility parameters for baseline and +CM conditions. Results confirmed that populations of monocytes exposed to CM had enhanced motility based on average speeds, average MSD10 and average total-diffusivity (FIG. 4L).

Taken together, we show that our single-cell framework is capable of directly quantifying dynamic behaviors and phenotypic heterogeneity across cellular conditions. Using this single-cell approach, we retain all the biological insights that can be determined from bulk analysis, while adding new ways to quantify phenotypic heterogeneity and direct visualization of cell motility data.

### Quantification of Dynamic Cell Behaviors Over Long Time Durations

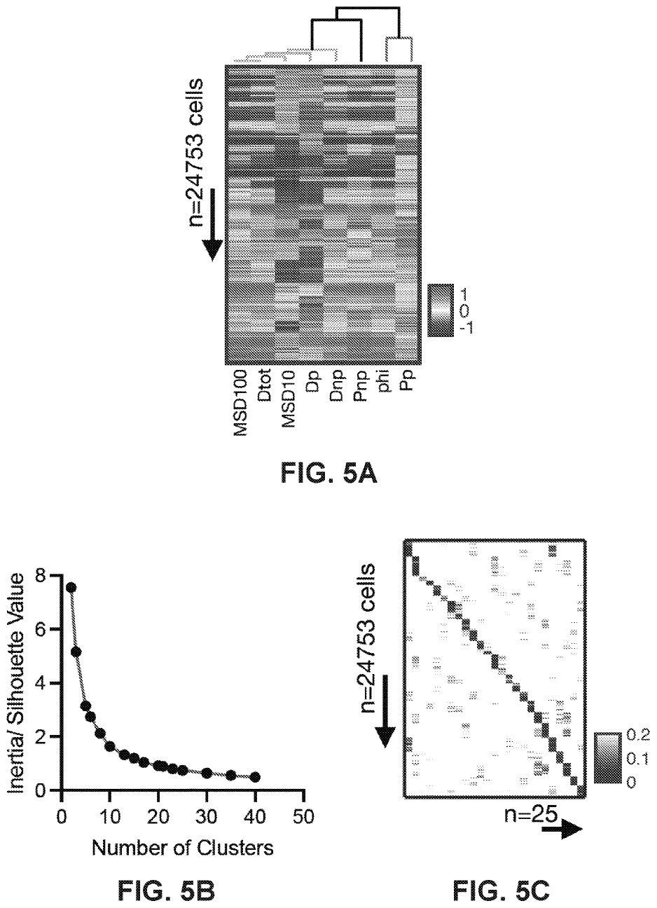

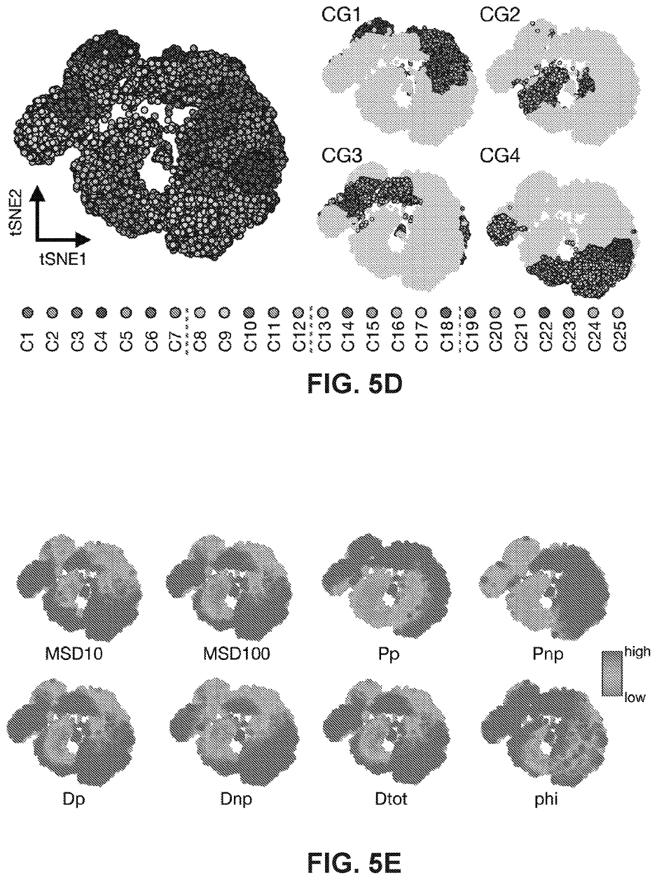

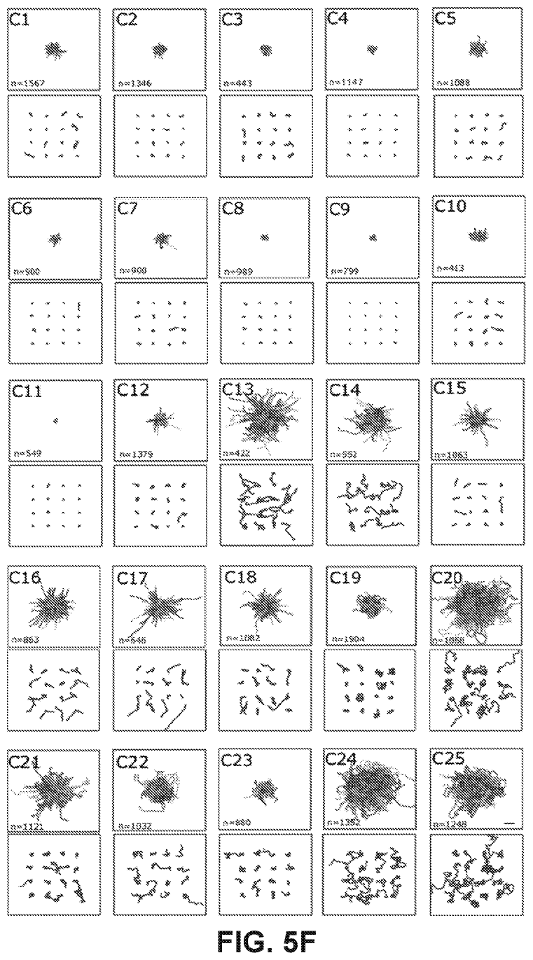

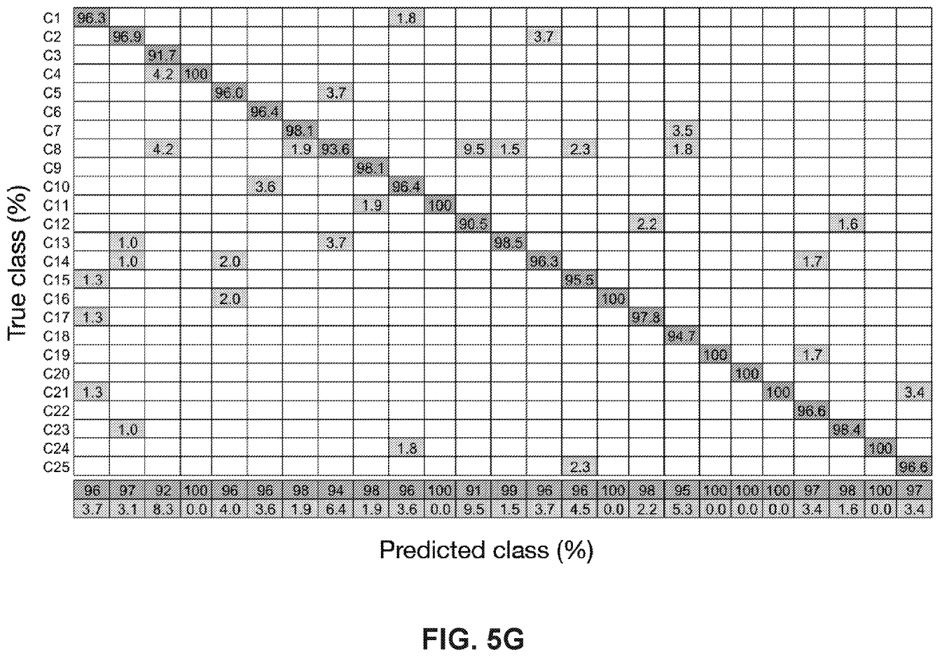

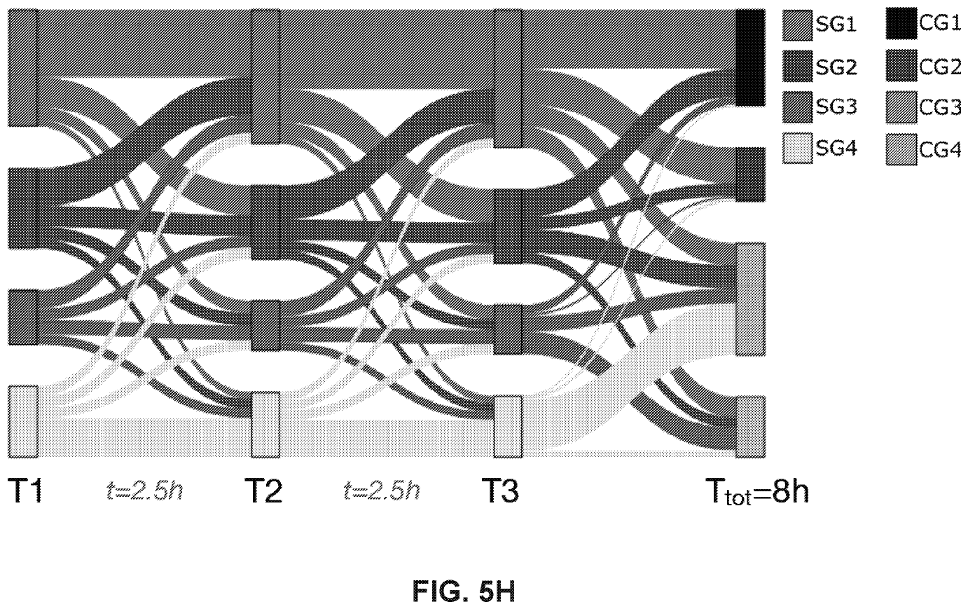

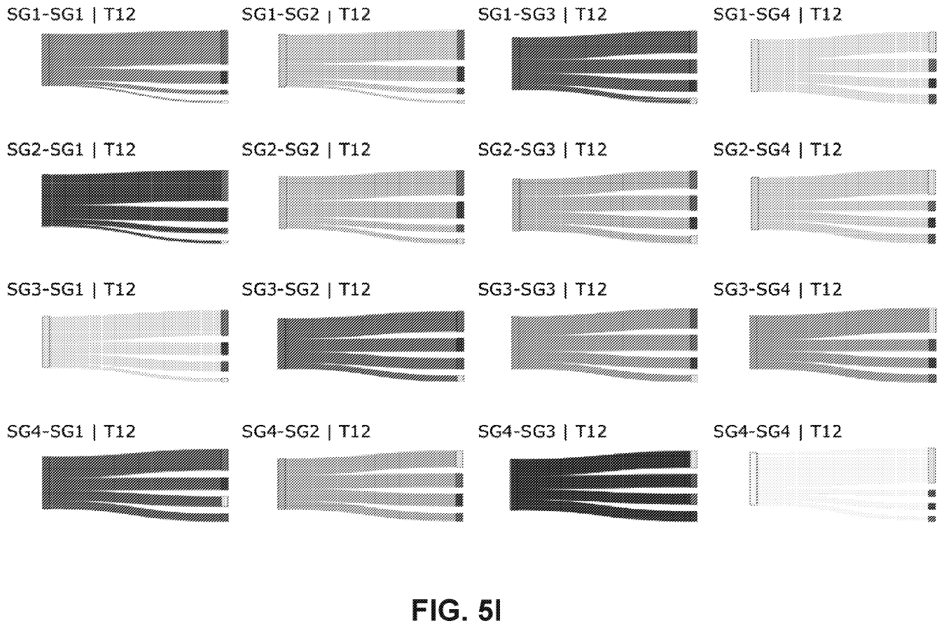

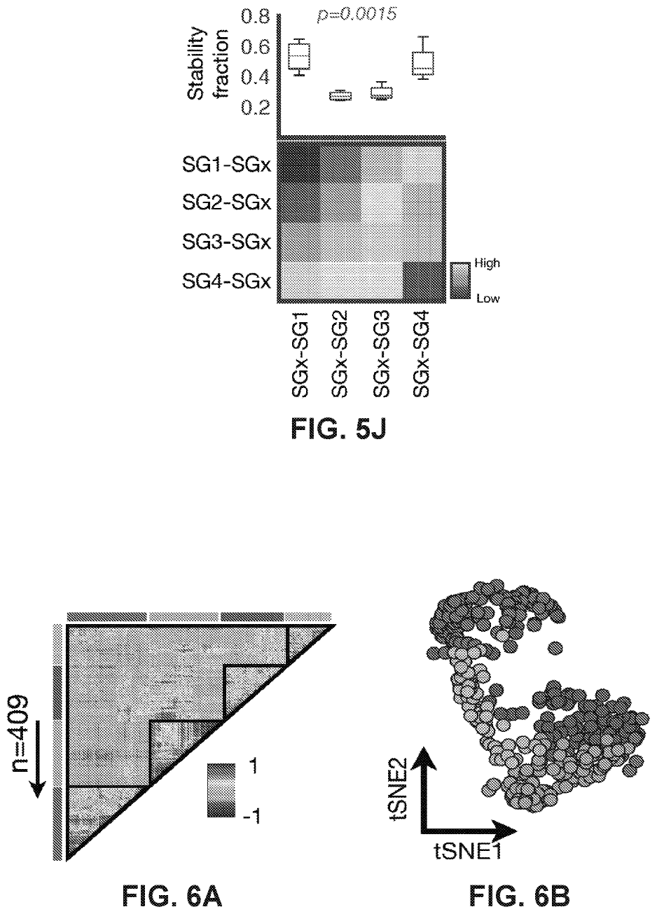

For a subset of cells within the combined dataset, we had more than eight hours of continuous cell tracking data. As a result, we wondered whether additional dynamic patterns could be captured from longer movies, thereby enabling subsequent interrogation of cell behaviors at both short and long durations. To evaluate this, we compiled cells having 8-hours of motility data at 5 minute intervals and computed the same eight motility parameters described above. With this data (n=24,753 cells) we performed k-means clustering analysis (FIG. 5A) and computed the inertia and silhouette values, from which we identified 25 clusters for long durations (FIG. 5B). The 25 clusters were confirmed based on the staircase plots highlighting the coherence within each cluster (FIG. 5C), with cells clustering within close proximity in two-dimensional tSNE space (FIG. 5D). These 25 clusters (CG1 to CG25) also separated into four behavior classes (CG1, CG2, CG3, CG4) based on unsupervised hierarchical clustering, displaying distinct patterns for the eight motility parameters (FIG. 5E). To visualize the patterns of motility within each cluster, we plotted the cells classified within each cluster, showing that the clusters were qualitatively and quantitatively able to denote different patterns of cell migration that grossly defined highly- and non-motile cells (FIG. 5F).

We next evaluated the ability to predict the motility pattern of unclassified cells. Using the same approach noted above, we trained a new linear SVM model on the 8-hour cell tracking data, and tested the prediction in a 90:10 split dataset, as well as newly simulated trajectories for 25,000 single cells. Results indicated a 97.2% accuracy for the 90:10 split dataset (FIG. 5G), and a 95.6% accuracy for the simulated trajectories. Taken together, we show the ability to also classify distinct patterns of cell motility for long durations of cell movements.

### Connecting Motility Patterns Across Short and Long Time Durations

In most cell motility analyses the inherent assumption of time-invariant movement or time-independence limits the ability to infer generalizable temporal cell behaviors. To understand the temporal transitions and infer temporal behaviors, we took advantage of the fact that we had both short and long duration data for a subset of cells. Using this information, we linked the analyses of motility patterns at short durations (2.5 hours that define 17 clusters) with motility patterns at long durations (8 hours that define 25 clusters). That is, for the subset of cells having 8 hours of movement, we cut each trajectory into three 2.5-hour segments and determined motility clusters and complimentary behavior classes (SG1-SG4 and CG1-CG4) within short and long durations. With this data, we asked whether a cell classified in a particular motility cluster or behavior class for the first 2.5 hours stayed within that class for subsequent 2.5-hour time segments. Overall, we observed that for the ~24,000 cells evaluated, cells tended to stay within the same behavior class for the continuous three time-segments if they were classified within classes SG1 and SG4 (FIG. 5H), whereas cells classified in SG2 and SG3 tended to change behavior classes along subsequent segments. From this, we computed the conditional probabilities of transition for each behavior class (SG1-SG4) (FIG. 5I), highlighting that SG1 and SG4 had higher temporal stabilities relative to SG2 and SG3 (FIG. 5J). Furthermore, there was an association between short and long durations, with classes in long durations being associated with differential short duration classes; e.g. CG2 was mainly comprised of SG1 and SG3 cells, and CG1 was primarily comprised of SG1 with a minority of SG2 cells (FIG. 5H).

Taken together, we describe the ability to quantify temporal dynamics of the motility patterns at short and long time durations. This is particularly important, as it provides a new way to overcome the limitations imposed by the assumption of time-invariance. By separating cell trajectories into shorter time segments, where the time-invariance assumption is valid, we can decipher spatio-temporal patterns that accurately describes spatio-temporal behaviors of cells. With all of these steps, from data harmonization and integration to spatio-temporal classification we define haLo, which can be used to describe dynamic cell behaviors.

Using haLo to Decipher Functional Heterogeneity Across Conditions

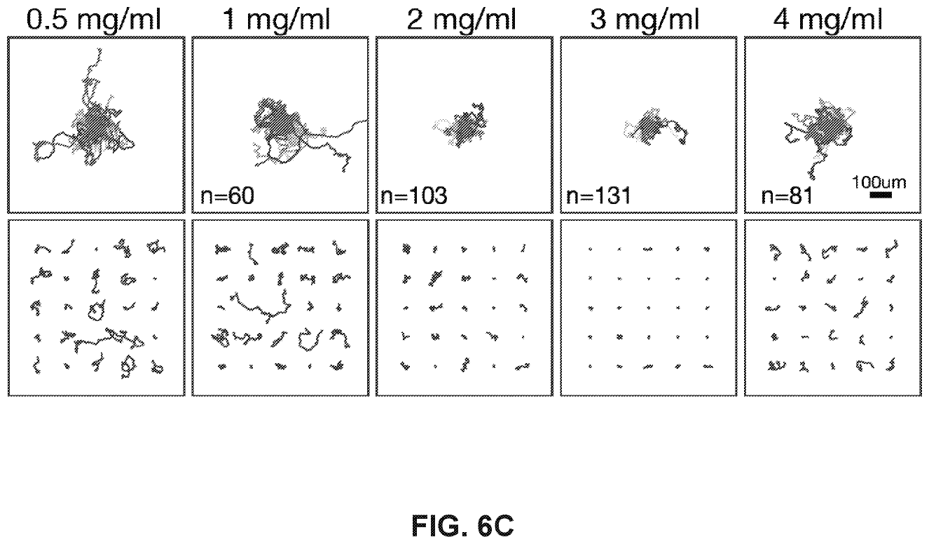

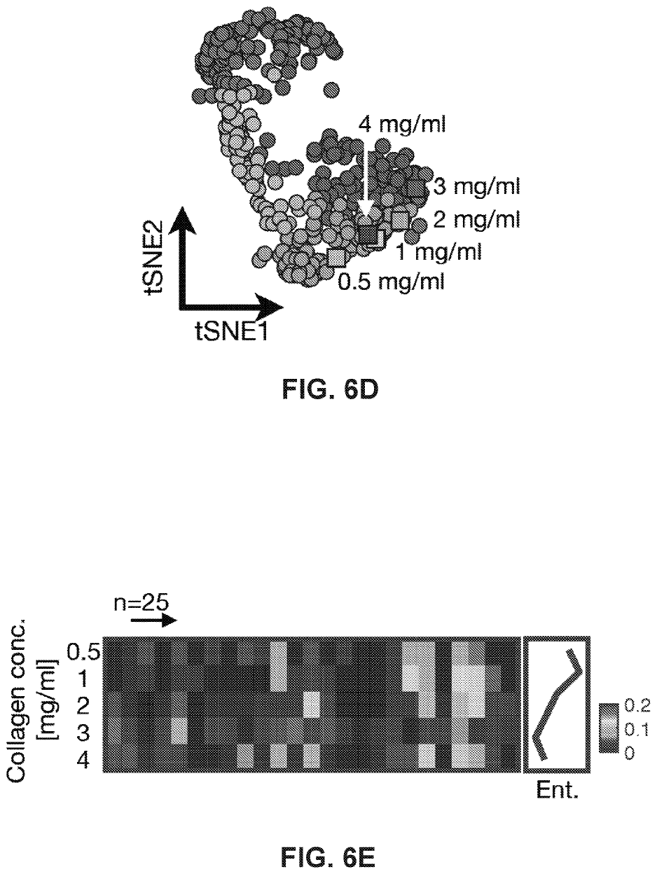

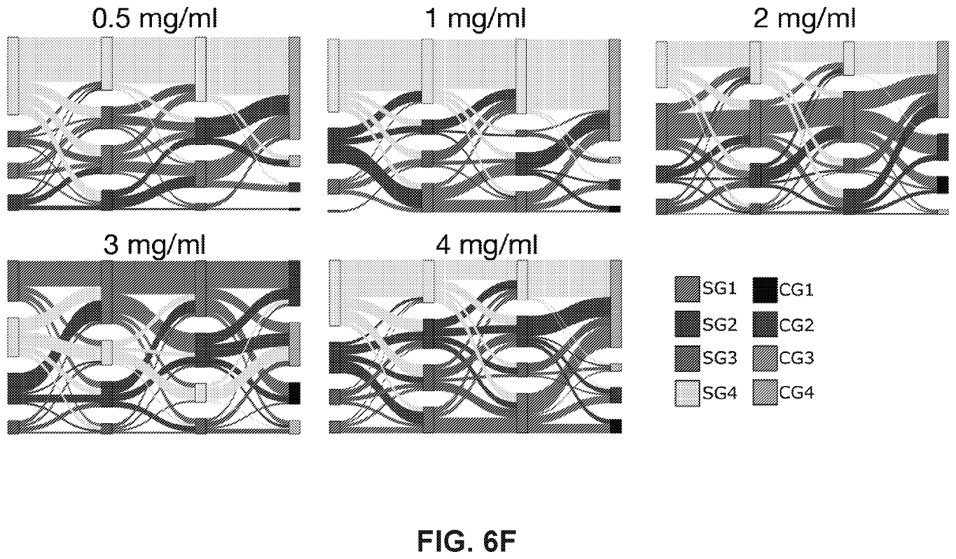

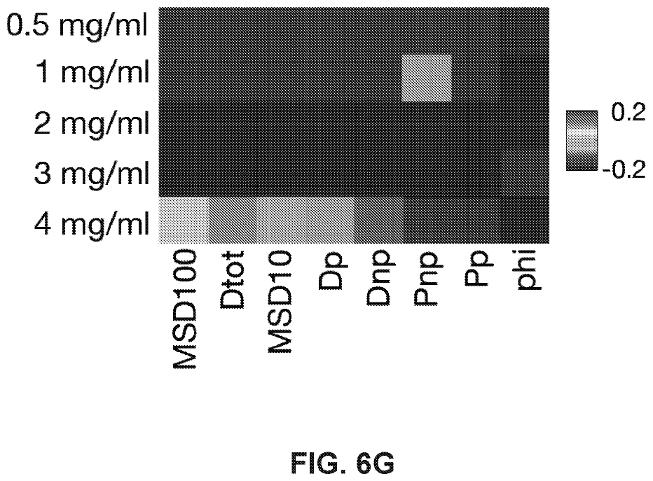

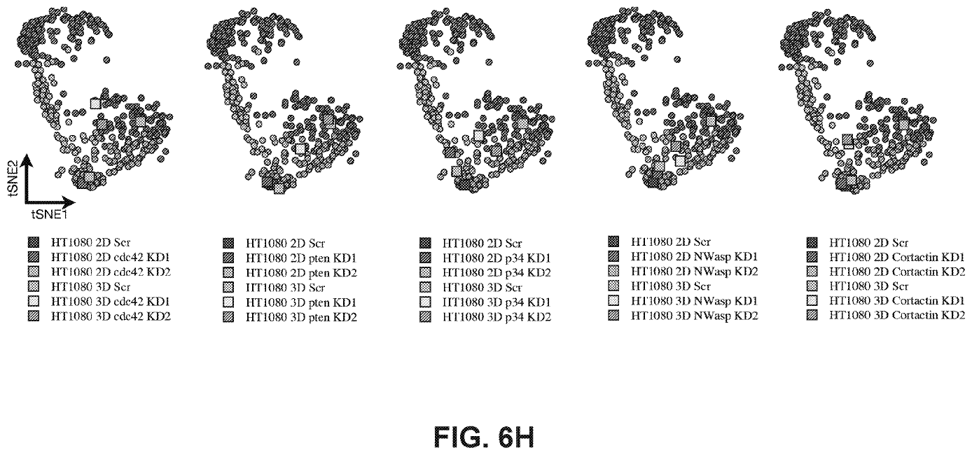

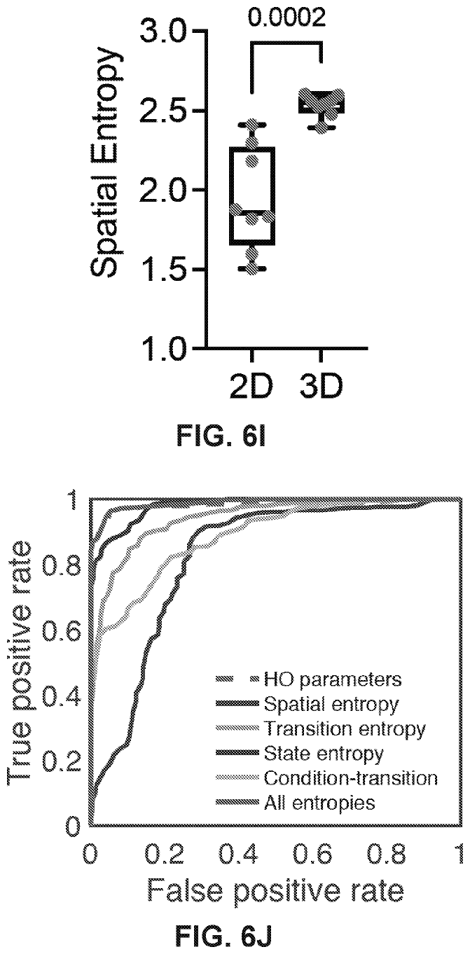

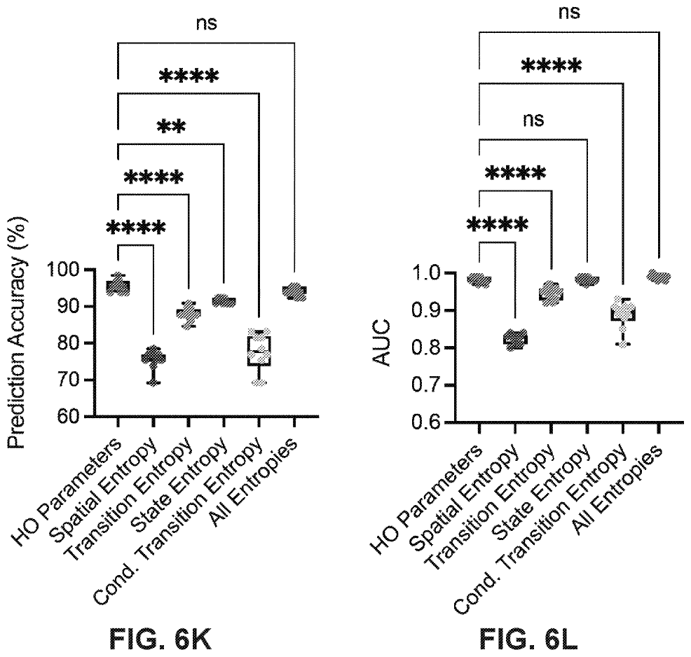

Given the ability to profile dynamic behaviors of single cells using halo, we tested the ability to derive key biological insights that are not fully appreciated from conventional motility analyses. Using a subset of data taken from long durations movies (i.e. 8 hours), we performed hierarchical clustering based on cross-correlation analysis across the 409 conditions. This yielded four groups, as shown in both the cross-correlation heatmap (FIG. 6A) and two-dimensional tSNE plots (FIG. 6B). As a biological test-case, we took data from LY12 cells (T-cell lymphoma cells) moving in 3D Collagen-1 gels across five different collagen concentrations. Plotting the trajectories of cells within each condition, we qualitatively observed a bi-phasic response in the magnitude of the motility, with the lowest cell motility observed at 3 mg/ml collagen (FIG. 6C). Plotting these condition in the 2D t-SNE space (FIG. 6B), we quantitatively observed a bi-phasic or switching effect, with cells moving from the green region (low collagen concentration) to the purple region (high collagen-3 mg/ml), then back to green region for 4 mg/ml (FIG. 6D). Highlighting a switch in the motility phenotypes based on spatial motility patterns (similar motility for 1 mg/ml and 4 mg/ml). This switching phenotype with changing collagen concentrations is likely due to local changes in molecular crowding effects based on collagen alignment and porosity. Furthermore, plotting the abundance of cells within the 25 clusters for each condition, we also observed a bi-phasic response in the heterogeneity itself (defined based on the Shannon entropy), with a minimization at 3 mg/ml (FIG. 6E).

Given these striking spatial associations with collagen concentration, we asked whether there were complimentary temporal associations based on short and long time durations. To address this, we stacked the three 2.5-hour time segments, paying attention to the fraction of cells within each short duration behavior classes (SG1 to SG4) and the frequency at which cells switched classes with increasing concentrations. From this analysis, we also observed a switching/bi-phasic phenotype based on temporal associations, with the majority of cells staying in SG4 (yellow) across the three segments for 0.5 mg/ml, 1 mg/ml and 4 mg/ml, an increase towards SG1 for 2 mg/ml, and a shift towards SG1 as the dominant behavior class for 3 mg/ml (FIG. 6F). Furthermore, while this phenotype-switch is observed spatially at 3 mg/ml, from the temporal perspective this shift is already apparent at 2 mg/ml and is enhanced at 3 mg/ml. These temporal switching dynamics across conditions was not only observed for LY12 cells, but was also observed in conditions for other cell types upon drug treatments or knock-downs using different shRNAs. These generalized findings establish the general utility of halo, and the ability to determine new insights into motility patterns in multiple biological settings. In addition, haLo analysis provides the ability to quantify dynamic phenotypic transitions to identify precursor shifts in phenotypes prior to the complete switching (i.e. 2 mg/ml shows a trend towards switching from SG4 to SG1 prior to SG1 becoming dominant at 3 mg/ml).

Taken together, halo enables the quantification of real spatial-temporal dynamics and heterogeneities that define bi-phasic and phenotype-switching responses to increasing collagen concentration. These results highlight aspects of cells motility that cannot be fully appreciated from conventional bulk motility analysis (FIG. 6G).

### Predicting Dimensionality of Cellular Conditions Based on Spatial and Temporal Heterogeneities

Given the ability to dynamically map cell behaviors, both spatially and temporally, we wondered whether we could use haLo to predict the dimensionality of cells moving in 2D and 3D microenvironments. Recent studies have demonstrated that cell movements in 2D do not predict 3D movements^{17,25,26}, which is especially applicable in studies involving the characterization of metastasis and cancer cell invasion. Furthermore, it is not well understood why there is such a disconnect in movements behaviors in 2D and 3D microenvironments, where 2D cancer cell migration is not predictive of cancer cell invasion. To elucidate what defines this difference, we evaluated cell motility patterns in 60 matched 2D and 3D conditions. These conditions comprised HT1080 cells under multiple genetic and drug-induced perturbations, including knockdowns using different shRNAs and concentration-dependent drug treatments. This wide range of perturbations allows the proper interrogation of the universe of movement-patterns exhibited by cells moving in 2D and 3D microenvironments. Mapping the 2D and 3D conditions in t-SNE space, we observed differential localization across regions, indicating inherent differences in the motility patterns of the cells, with cells in 3D microenvironments exhibiting higher heterogeneities (FIG. 6H). This differential localization within the 2D t-SNE space was not only observed in knockdown conditions, but also as a function of drug concentrations in HT1080 cells and other cell types. Interestingly, we did not observe dimension-exclusive motility clusters, meaning that cells in both 2D and 3D conditions were classified within each of the 25 long duration motility clusters. However, the fractional abundance of cells within each cluster varied between 2D and 3D.

Prompted by these results, we asked whether we could predict the dimensionality of moving cells based on the phenotypic heterogeneity of cell populations, as cells in 3D tended to exhibit higher phenotypic heterogeneities relative to matched 2D conditions (FIG. 6I). To comprehensively define the heterogeneity, we defined four types of entropies that captured spatial and temporal nature of cells (see Methods). These different types of entropy denoted: (1) spatial entropy, which is computed based on the fractional abundance in each motility cluster (n=17 or n=25), (2) state entropy, which is based on the fractional abundance of cells within short duration and/or long duration classes (SG1-SG4, CG1-CG4), (3) transition entropy, which is computed based on the probability of transitioning from one short duration behavior class to the other along subsequent time segments, and (4) conditional-transition entropy, estimates the entropy based on the conditional probabilities that define the likelihood of transitioning to a specific short duration class. We then trained a model to predict the dimensionality of cells using a linear SVM (see Methods). Comparing the prediction accuracies using either the eight motility parameters, the individual entropies, or the combination of all four entropies, we found that the combination of entropies was able to predict the dimensionality in more than 95% of the cases. This was comparable to using the eight motility parameters to predict the dimensionality (FIG. 6J-K).

Taken altogether, we show the ability of halo to predict patterns of cell movements and derive biological insights across cellular conditions, such as how the dimensionality of the microenvironment influences the dynamic behaviors. Furthermore, we show that understanding phenotypic heterogeneity is critical to interpreting spatio-temporal behaviors.

### DISCUSSION

Cell movements play a critical role in the physiology of organisms, both in the context of homeostasis and disease. Conventionally, cell motility is quantified using small numbers of cells and reported as bulk averages of cell populations. haLo is a computational framework that takes advantage of the single-cell nature and spatio-temporal dynamics of cell motility data, enabling the harmonization of datasets across multiple conditions (FIG. 3). Here, we have demonstrated the utility of halo to quantify cell motility patterns (FIG. 4), determine spatial and temporal heterogeneities (FIG. 5), define dynamic phenotypic transitions, and predict the dimensionality of cellular conditions (FIG. 6). In addition, haLo provides a clear visualization scheme of single-cell behaviors to enable direct interpretation of motility data, while retaining all the biological information that is typically gained from conventional bulk analyses. Furthermore, we show that haLo can be used to classify dynamic cell behaviors both in vitro and in vivo settings, and in response to genetic and chemical perturbation, e.g. drugs, shRNAs (FIG. 6H).

While haLo provides a robust solution to decipher emergent patterns of single-cell behaviors there are certain contexts where it may exhibit limitations. A key limitation of halo is that since cell motility clusters are derived based on multivariate statistical approaches of combined motility datasets, (i.e. spanning multiple cell types, dimensionalities, and perturbations), only dominant cell motility patterns would be identified as clusters. As a result, rare patterns of cell motility may not be identified as distinct, but will be classified within larger, dominant clusters. While this is the case in most big-data classifications, we are confident that halo can provide reliable and insightful information, as demonstrated by the high cluster coherence (i.e. minimal distances of each cell to its cluster centroid). In any case, in conditions where cell-type or condition-specificity is critical, an alternative application of haLo may be needed. One way around this is to train the classification model based on a specific cell-type, or condition, as we have previously shown. However, the dataset (i.e. number of cells) needs to be large enough to be robust and reproducible. Lastly, haLo is designed as a comparative tool, where cellular conditions are differentiated based on the fractional redistribution among defined cell patterns. As such, multiple comparative conditions are needed to derive biological insights and to understand how a given perturbation influences the resistant cell behaviors, based on the abundance of cells within each cluster.

In summary, we have demonstrated the utility of haLo to identify and classify dynamic single-cell behaviors across multiple conditions. We anticipate that increased implementation of modern single-cell approaches and data science analyses will lead to better understanding of dynamic cellular behaviors and heterogeneity. While haLo provides a robust approach to quantify functional cell behaviors, additional work is needed to better understand phenotypic transitions and mechanistic connections of cell behaviors to underlying molecular states. Recently, studies have started to multiplex functional cell behaviors with underlying genetic and epigenetic states of cells. However, many more studies are needed to comprehensively assess and establish deterministic links between cell motility patterns and underlying molecular modifications (e.g. cells with knock-downs in particular genes). Ultimately, multiplexed in situ quantification of molecular and phenotypic behaviors quantified simultaneously could enable precision health approaches where dynamic cell behaviors can be linked to disease states. This will be particularly important in light of cellular heterogeneity that exist in populations of cells and its association to clinical outcomes and treatment responses.

### Materials and Methods

### Data Curation

Data for the classification of cell motility patterns was generated based on the x-y coordinates along cell movement trajectories. To procure data for analysis, we used existing motility from published papers as well as newly acquired data. For each dataset, we stored the x and y coordinates, total duration, interval time, pixel size for calibration, and condition descriptions. This matrix of data was compiled for each cell and used to generate the corrected datasets for analysis (2.5-hours total duration at 5-minute intervals, or 8-hours total durations at 5-minute intervals).

### Calculation of Higher Order Parameters Using Anisotropic Persistence Random Walk (APRW)

To quantify the spatio-temporal motility patterns, we analyzed bulk cell movements based on trajectories using Anisotropic Persistent Random Walk model (APRW)^{17,21} From this analysis we generated the parameters that describe the movements of the cells, namely, MSD10, MSD100, Dtot, Dp, Dnp, Pp, Pnp, and ¢. We chose to calculate MSD10 and MSD100 since the denote regimes shorter and longer than the average persistence time across all conditions. We used the following equations to estimate the motility parameters.

$$MSD ( τ ) = 〈 {( x ( t + τ ) - x ( t ) )}^{2} + {( y ( t + τ ) - y ( t ) )}^{2} 〉 \qquad ( 1 )$$

$${MSD}_{p} ( τ ) = {S}_{p}^{2} {P}_{p} ( τ - {P}_{p} ( 1 - {e}^{- τ / {P}_{p}} ) + 2 {σ}_{p}^{2} ) \qquad ( 2 )$$

$${MSD}_{np} ( τ ) = {S}_{np}^{2} {P}_{np} ( τ - {P}_{np} ( 1 - {e}^{- τ / {P}_{np}} ) + 2 {σ}_{np}^{2} ) \qquad ( 3 )$$

$${D}_{p} = \frac{{S}_{p}^{2} {P}_{p}}{4} \qquad ( 4 )$$

$${D}_{np} = \frac{{S}_{np}^{2} {P}_{np}}{4} \qquad ( 5 )$$

$${D}_{tot} = {D}_{p} + {D}_{np} \qquad ( 6 )$$

$$ϕ = \frac{{D}_{p}}{{D}_{np}} \qquad ( 7 )$$

where S is the cell speed, P is the persistence time, 2σ² is the noise (error) in the position of the cell, T=n Δt and n=1, 2, . . . . Nₘᵢₙ−1, Δt is the size of the time step.

The eight motility parameters used for all analyses include the magnitudes of cellular displacements and speeds (MSD10, MSD100, SP10, and SP100), the total diffusivity and diffusivities along primary and secondary axes of migration (Dtot, Dp, and Dnp), the persistence times along the primary and secondary axes of migration (Pp, Pnp), and the spatial persistence/anisotropy (q). Time lags of 10 and 100 (used for the MSD's and speeds) were selected based on the average persistence times across datasets, 10 minutes were on the order of average persistence time and 100 minutes being greater than the average persistence time.

### Parameters and Descriptions

### Normalized Mean Squared Displacement (MSD) Calculation

Mean Squared Displacement (MSD) per time point was normalized with respect to their corresponding time interval. For the non-homogenized trajectories, the following equation was used:

$$\frac{MSD ( {τ}_{a} )}{{τ}_{a}} \qquad ( 8 )$$

where, Ta is the time interval of the actual non-homogenized trajectory. We used pseudo-Monte-Carlo to extract the normalized MSDs at varying time intervals as follows:

$$\frac{MSD ( {τ}_{i} )}{{τ}_{i}} \qquad ( 9 )$$

where, Tᵢ is the time interval used (Tᵢ=2, 2.5, 3, 3.5, . . . 10 min).

### Pseudo-Monte-Carlo Technique to Predict y-t Locations of Cells at a Given Time Point

First, we estimate the required (or, missing) X-Y location from linear interpolation (X_{interp,i}) y_{interp,i}). Then, we employ a small perturbation to the estimated location of the cell obtained through linear interpolation. The perturbation for the location at i^{th} time point is employed as follows:

$${x}_{pMC , i} = {x}_{interp , i} + {δ}_{x , i} ; \qquad ( 10 )$$

$${y}_{pMC , i} = {y}_{interp , i} + {δ}_{y , i} ; \qquad ( 11 )$$

$${δ}_{x , i} = \frac{( {x}_{i + 1} - {x}_{i - 1} )}{pMCF} ( \vert {x}_{i + 1} - {x}_{i - 1} \vert \geq \vert {y}_{i + 1} - {y}_{i - 1} \vert ) ; \qquad ( 12 )$$

$${δ}_{y , i} = \frac{( {y}_{i + 1} - {y}_{i - 1} )}{pMCF} ( \vert {x}_{i + 1} - {x}_{i - 1} \vert \leq \vert {y}_{i + 1} - {y}_{i - 1} \vert ) \qquad ( 13 )$$

The goodness of pMC method is then checked by varying the pMC factor (pMCF) and comparing with the corresponding Higher Order parameters (in case there is a reference trajectory at a given time interval) or through comparing Normalized MSDs (in case there is no reference trajectory at a given time interval).

### Assessing Concordance Among Varied Time Intervals

To geometrically compare different cell trajectories, we used a concordance analysis, which calculates the area of triangles formed along subsequent points along a given trajectory. For concordance analysis regarding varying time intervals per trajectory, we calculated the area of triangle made by points t₁-t₂-t₃, t₃-t₄-t₅ and so on. For concordance analysis regarding interpolation-predicted trajectories, we calculated the area of triangle made by points t₁-tᵢ₂-t₃, t₃-tᵢ₄-t₅ and so on and for pMC predicted trajectory, we calculated the area of triangle made by points t₁-tᵢ₂-tᵢ₃, tᵢ₃-tᵢ₄-tᵢ₅.

### Clustering Analysis, Evaluating Cluster Stability and Cluster Coherence

For clustering analysis, we utilized either k-means clustering or unsupervised hierarchical clustering in Matlab. To analyze cluster stability, we used two factors: Inertia and Silhouette Values. Inertia values were based on the elbow method to identify the number of clusters when minimal additional data is gained with the increase in the number of clusters²². Silhouette values are calculated using MATLAB's silhouette function. To compute cluster coherence, we computed the Euclidean distances between z-score, log normalized motility parameters for each cell and z-score, log normalized motility parameter values of the centroid of each cluster (obtained through k-means clustering).

### Simulation of Trajectories

To simulate trajectories, we used APRW based simulation of trajectories as detailed in Wu et al (Statistical analysis of cell migration in 3D using the anisotropic persistent random walk model. Nat. Protoc. (2015)).

Support Vector Machine (SVM) Based Data Classification and Model prediction

We used MATLAB's SVM function to train on datasets and predict from the trained model. The data partitions for training and validation are detailed in the respective figure captions. To get the cluster of a single cell, first, we calculate higher order parameters of the cell. Then we performed z-score, log normalization to receive the input for a single cell to the SVM based classification.

### Centroid Based Prediction

To validate SVM based prediction, we used centroid based classification system which computes the Euclidean distance between z-score, log normalized higher order parameters of each cell (whose cluster is to be predicted) and z-score, log normalized higher order parameter values of the centroid (obtained through k-means clustering) of each cluster. Cluster assignment is then based on the cluster which demonstrated least Euclidean distance.

### Sankey Dataset Calculation

To plot the temporal Sankey datasets, we first divided the clusters into pertinent groups: SG1, SG2, SG3 and SG4 for 2.5 hrs datasets and CG1, CG2, CG3 and CG4 for 8 hrs datasets. We then linked the temporal transition of 2.5 hrs trajectories to their respective 8 hrs trajectories. Hence, three temporal segments of 2.5 hrs trajectories were plotted.

### Entropy Calculations

Spatial Entropy—To compute spatial entropy we used the occurrences of 8 hrs trajectories of the biological condition under consideration. We then computed entropy using the following equation:

$${S}_{spatial} = - {\sum }_{i = 1}^{25} {p}_{i} ln ( {p}_{i} ) \qquad ( 14 )$$

The occurrences are probabilities (pᵢ) of cells in each n=25 clusters (i=1,2,3 . . . 25).

State Entropy—To compute state entropy, we calculated the probability of each group SG1, SG2, SG3, SG4 at each time segment, T1, T2 and T3 (equation 15) and CG1, CG2, CG3 and CG4 for the last segment of the temporal Sankey (equation 16).

$${S}_{state} {\vert}_{T 1 , T 2 , T 3} = - {\sum }_{i = 1}^{4} {p}_{SGi} ln ( {p}_{SGi} ) \qquad ( 15 )$$

$${S}_{state} {\vert}_{C} = - {\sum }_{i = 1}^{4} {p}_{CGi} ln ( {p}_{CGi} ) \qquad ( 16 )$$

Sₛₜₐₜₑ|_{T1}, Sₛₜₐₜₑ|_{T2}, Sₛₜₐₜₑ|_{T3} are calculated separately from equation (15).

Transition Entropy-Transition entropy measures the heterogeneity in the distribution of transition from one-time segment to another.

$${S}_{transition} {\vert}_{\begin{matrix}T 1 \to T 2 ; T 2 \to T 3 ; \\ T 3 \to C\end{matrix}} = - {\sum }_{i = 1}^{4} {\sum }_{j = 1}^{4} {p}_{ij} ln ( {p}_{ij} ) \qquad ( 17 )$$

For computation of pᵢⱼ to estimate Sₜᵣₐₙₛᵢₜᵢₒₙ|_{T1→T2}; Sₜᵣₐₙₛᵢₜᵢₒₙ|_{T2→T3}; we used equation (18) which uses the transition from SGi to SGj (groups of 2.5 hrs trajectories). For computation of pᵢⱼ to estimate Sₜᵣₐₙₛᵢₜᵢₒₙ|_{T3→C}, we used equation (19), which uses the transition from SGi (groups of 2.5 hrs trajectories) to CGj (groups of 8 hrs trajectories).

$${p}_{ij} = [ \begin{matrix}{p}_{SG 1 \to SG 1} & {p}_{SG 1 \to SG 2} & {p}_{SG 1 \to SG 3} & {p}_{SG 1 \to SG 4} \\ {p}_{SG 2 \to SG 1} & {p}_{SG 2 \to SG 2} & {p}_{SG 2 \to SG 3} & {p}_{SG 2 \to SG 4} \\ {p}_{SG 3 \to SG 1} & {p}_{SG 3 \to SG 2} & {p}_{SG 3 \to SG 3} & {p}_{SG 3 \to SG 4} \\ {p}_{SG 4 \to SG 1} & {p}_{SG 4 \to SG 2} & {p}_{SG 4 \to SG 3} & {p}_{SG 4 \to SG 4}\end{matrix} ] \qquad ( 18 )$$

$${p}_{ij} = [ \begin{matrix}{p}_{SG 1 \to CG 1} & {p}_{SG 1 \to CG 2} & {p}_{SG 1 \to CG 3} & {p}_{SG 1 \to CG 4} \\ {p}_{SG 2 \to CG 1} & {p}_{SG 2 \to CG 2} & {p}_{SG 2 \to CG 3} & {p}_{SG 2 \to CG 4} \\ {p}_{SG 3 \to CG 1} & {p}_{SG 3 \to CG 2} & {p}_{SG 3 \to CG 3} & {p}_{SG 3 \to CG 4} \\ {p}_{SG 4 \to CG 1} & {p}_{SG 4 \to CG 2} & {p}_{SG 4 \to CG 3} & {p}_{SG 4 \to CG 4}\end{matrix} ] \qquad ( 19 )$$

Conditional Transition Entropy-We measured the heterogeneity in distribution in motility groups, given a specific group of a time segment. There are three types of conditional transition entropies that can link the three-time segments of 2.5 hrs trajectories (T1, T2 and T3). S_{x→i→j}; S_{i→x→j}; S_{i→j→x} (The temporal transitions are defined as follows-T1: SGx, T2: SGi, T3: SGj, OR, T1: SGi, T2: SGx, T3: SGj, OR, T1: SGi, T2: SGj, T3: SGx, where, SGx is a given group in the respective time segment).

$${p}_{ij}^{x}$$

is the probability of transition from SGi to SGj given, SGx (at the respective time segment, namely, T1, T2, or, T3).

$${S}_{cond . trans .} {\vert}_{\begin{matrix}x \to i \to j ; i \to x \to j ; \\ i \to j \to x\end{matrix}} = - {\sum }_{i = 1}^{4} {\sum }_{j = 1}^{4} {p}_{ij}^{x} ln ( {p}_{ij}^{x} ) \qquad ( 20 )$$

$${p}_{ij}^{x} = [ \begin{matrix}{p}_{SG 1 \to SG 1}^{x} & {p}_{SG 1 \to SG 2}^{x} & {p}_{SG 1 \to SG 3}^{x} & {p}_{SG 1 \to SG 4}^{x} \\ {p}_{SG 2 \to SG 1}^{x} & {p}_{SG 2 \to SG 2}^{x} & {p}_{SG 2 \to SG 3}^{x} & {p}_{SG 2 \to SG 4}^{x} \\ {p}_{SG 3 \to SG 1}^{x} & {p}_{SG 3 \to SG 2}^{x} & {p}_{SG 3 \to SG 3}^{x} & {p}_{SG 3 \to SG 4}^{x} \\ {p}_{SG 4 \to SG 1}^{x} & {p}_{SG 4 \to SG 2}^{x} & {p}_{SG 4 \to SG 3}^{x} & {p}_{SG 4 \to SG 4}^{x}\end{matrix} ] \qquad ( 21 )$$

### Predicting 2D vs. 3D

To perform the prediction of cells moving in either 2D or 3D, we trained a linear SVM for each of the entropies, based on 25 iterations of 90:10 split of the 60 conditions. The final accuracy results are reported as the average values for each of the 25 iterations.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

1. A computer-implemented method of determining a biological condition of a cell from a test subject, the method comprising:
passing a cell motility data set obtained from the test subject through an electronic neural network, wherein the electronic neural network has been trained on a set of training data that comprises a plurality of harmonized cell motility data sets obtained from reference subjects that are each labeled with one or more biological conditions; and,
outputting from the electronic neural network the biological condition of the cell from the test subject based upon one or more patterns or clusters of data points present in the plurality of harmonized cell motility data sets.

2. The method of claim 1, wherein two or more of the plurality of cell motility data sets obtained from the reference subjects are substantially non-uniform with one another.

3. The method of claim 1, wherein the plurality of cell motility data sets comprises video images and/or tracking data of cells obtained from the reference subjects; wherein the plurality of cell motility data sets comprises images of cells and/or the coordinates of cell trajectories in either two-dimensional (2D) or three-dimensional (3D) microenvironments obtained from the reference subjects; or wherein the plurality of cell motility data sets lacks averaged data points or parameters.

4. (canceled)

5. (canceled)

6. The method of claim 1, comprising determining the biological condition of the cell from the test subject in substantially real-time.

7. The method of claim 1, wherein the cell motility data set obtained from the test subject comprises in vitro data points; wherein the cell motility data set obtained from the test subject comprises ex vivo data points; or wherein the cell motility data set obtained from the test subject comprises in vivo data points.

8. (canceled)

9. (canceled)

10. The method of claim 1, wherein the plurality of harmonized cell motility data sets obtained from the reference subjects comprises in vitro data points; wherein the plurality of harmonized cell motility data sets obtained from the reference subjects comprises ex vivo data points; or wherein the plurality of harmonized cell motility data sets obtained from the reference subjects comprises in vivo data points.

11. (canceled)

12. (canceled)

13. The method of claim 1, comprising quantifying a cell motility value for the cell from the test subject.

14. The method of claim 1, wherein the biological conditions are selected from the group consisting of: a cell type, a disease state, a genotype, a phenotype, a drug exposure, a spatial heterogeneity, and a temporal heterogeneity.

15. The method of claim 1, wherein the plurality of harmonized cell motility data sets is obtained from multiple sources having different acquisition settings.

16. The method of claim 1, wherein the biological condition of the cell from the test subject comprises an identification and classification of a single-cell motility behavior, a quantification of phenotypic heterogeneities, a visualization scheme to quantitatively interpret the biological condition, and/or predict motility patterns of the cell.

17. The method claim 1, comprising mapping temporal transitions among different cell motility behaviors exhibited by the cell.

18. A system for determining a biological condition of a cell from a test subject using an electronic neural network, the system comprising:
a processor; and
a memory communicatively coupled to the processor, the memory storing instructions which,
when executed on the processor, perform operations comprising:
passing a cell motility data set obtained from the test subject through an electronic neural network, wherein the electronic neural network has been trained on a set of training data that comprises a plurality of harmonized cell motility data sets obtained from reference subjects that are each labeled with one or more biological conditions; and
outputting from the electronic neural network the biological condition of the cell from the test subject based upon one or more patterns or clusters of data points present in the plurality of harmonized cell motility data sets.

19. The system of claim 18, wherein two or more of the plurality of cell motility data sets obtained from the reference subjects are substantially non-uniform with one another.

20. The system of claim 18, wherein the plurality of cell motility data sets comprises video images and/or tracking data of cells obtained from the reference subjects; wherein the plurality of cell motility data sets comprises images of cells and/or the coordinates of cell trajectories in either two-dimensional (2D) or three-dimensional (3D) microenvironments obtained from the reference subjects; or wherein the plurality of cell motility data sets lacks averaged data points or parameters.

21. (canceled)

22. (canceled)

23. The system of claim 18, wherein the cell motility data set obtained from the test subject comprises in vitro data points; wherein the cell motility data set obtained from the test subject comprises ex vivo data points; or wherein the cell motility data set obtained from the test subject comprises in vivo data points.

24. (canceled)

25. (canceled)

26. The system of claim 18, wherein the plurality of harmonized cell motility data sets obtained from the reference subjects comprises in vitro data points; wherein the plurality of harmonized cell motility data sets obtained from the reference subjects comprises ex vivo data points; or wherein the plurality of harmonized cell motility data sets obtained from the reference subjects comprises in vivo data points.

27. (canceled)

28. (canceled)

29. The system of claim 18, wherein the biological conditions are selected from the group consisting of: a cell type, a disease state, a genotype, a phenotype, a drug exposure, a spatial heterogeneity, and a temporal heterogeneity.

30. The system of claim 18, wherein the plurality of harmonized cell motility data sets is obtained from multiple sources having different acquisition settings.

31. The system of claim 18, wherein the biological condition of the cell from the test subject comprises an identification and classification of a single-cell motility behavior, a quantification of phenotypic heterogeneities, a visualization scheme to quantitatively interpret the biological condition, and/or predict motility patterns of the cell.
